(19) United States
(12) Patent Application Publication
(10) Pub. No.: US 2016/0250097 A9
(43) Pub. Date: Sep. 1, 2016

(54) TREATMENT OF INFLAMMATION BY NON-INVASIVE STIMULATION

(71) Applicants: Kevin J. Tracey, Old Greenwich, CT (US); Howland Shaw Warren, Cambridge, MA (US); Michael Allen Faltys, Valencia, CA (US)

(72) Inventors: Kevin J. Tracey, Old Greenwich, CT (US); Howland Shaw Warren, Cambridge, MA (US); Michael Allen Faltys, Valencia, CA (US)

(73) Assignee: The Feinstein Institute for Medical Research, Manhasset, NY (US)

(21) Appl. No.: 12/048,114

(22) Filed: Mar. 13, 2008

Related U.S. Application Data
(63) Continuation-in-part of application No. 11/088,683, filed on Mar. 24, 2005, now Pat. No. 8,729,129.
(60) Provisional application No. 60/906,738, filed on Mar. 13, 2007.
(60) Provisional application No. 60/556,096, filed on Mar. 25, 2004.

(51) Int. Cl. A61H 23/00

(52) U.S. Cl. CPC A61H 23/00; A61H 2205/027

(57) ABSTRACT

Described herein are devices, systems and method for treating inflammatory disorders by modulating a subject's inflammatory reflex. The method may include the step of non-invasively stimulating the inflammatory reflex (e.g., the vagus nerve, the splenic nerve, the hepatic nerve, the facial nerve, and the trigeminal nerve) of a subject in a manner which significantly reduces proinflammatory cytokines in the subject and/or provides a therapeutically effective treatment for the subject. Devices for non-invasively stimulating the inflammatory reflex may include a movable tip or actuator that is controlled to mechanically stimulate the ear. The devices may be hand-held or wearable, and may stimulate the cymba conchae region of the subject's ear.

### CROSS-REFERENCE TO RELATED APPLICATIONS

This application claims the benefit of provisional patent application U.S. 60/906,738, filed on Mar. 13, 2007.

### GOVERNMENT SUPPORT

The invention was supported, in whole or in part, by a grant NIH R01GM057226 from the National Institute of Health. The Government has certain rights in the invention.

### BACKGROUND OF THE INVENTION

Inflammation is a complex biological response to pathogens, cell damage, and biological irritants. Inflammation may help an organism remove injurious stimuli, and initiate the healing process for the tissue. Inflammation is normally tightly regulated by the body. However, inappropriate or unchecked inflammation can also lead to a variety of disorder or disease states, including hay fever, atherosclerosis, arthritis (rheumatoid, bursitis, gouty arthritis, polymyalgia rheumatic, etc.), asthma, autoimmune diseases, chronic inflammation, chronic prostatitis, glomerulonephritis, nephritis, inflammatory bowel diseases, pelvic inflammatory disease, reperfusion injury, transplant rejection, vasculitis, myocarditis, colitis, sepsis, etc. In autoimmune diseases, for example, the immune system inappropriately triggers an inflammatory response, causing damage to its own tissues. Inflammatory disorders include a diverse group of illnesses with a wide array of symptoms. Inflammatory disorders have been treated pharmacologically with both steroidal and nonsteroidal anti-inflammatory compounds. Certain steroid anti-inflammatory compounds, such as corticosteroids, have serious side effects (reduced libido, impotence, amenorrhoea and infertility). Nonsteroidal anti-inflammatory drugs can also have serious side effects, including an increase in the risk of adverse cardiovascular events.

Inflammation can be classified as either acute or chronic. Acute inflammation is the initial response of the body to harmful stimuli and is achieved by the increased movement of plasma and leukocytes from the blood into the injured tissues. A cascade of biochemical events propagates and matures the inflammatory response, involving the local vascular system, the immune system, and various cells within the injured tissue. Prolonged inflammation, known as chronic inflammation, leads to a progressive shift in the type of cells which are present at the site of inflammation and is characterized by simultaneous destruction and healing of the tissue from the inflammatory process.

The nervous system, and particularly the vagus nerve, has been implicated as a modulator of inflammatory response. The vagus nerve is part of the inflammatory reflex, which also includes the splenic nerve, the hepatic nerve, the facial nerve, and the trigeminal nerve. This pathway may involve the regulation of inflammatory cytokines and/or activation of granulocytes. For example, Tracey et. al., have previously reported that the nervous system regulates systemic inflammation through a vagus nerve pathway. In particular, Tracey et al. developed new methods of treating inflammatory disorders by stimulating the vagus nerve signaling. See, e.g., U.S. Pat. No. 6,610,713; U.S. Pat. No. 6,838,471; U.S. 2005/0125044; U.S. 2005/0282906; U.S. 2004/0204355; U.S. 2005/0137218; and U.S. 2006/0178703. Thus, it is believed that appropriate modulation of the vagus nerve may help regulate inflammation.

Most devices and systems for stimulating nerves of the inflammatory reflex such as the vagus nerve are not appropriate for regulation of inflammation and/or are highly invasive.

For example, US Patent Application publication numbers 2006/0287678, US 2005/0075702, and US 2005/0075701 to Shafer describe an implanted device for stimulating neurons of the sympathetic nervous system, including the splenic nerve to attenuate an immune response. Similarly, US Patent Application publication numbers 2006/0206155 and 2006/010668 describe stimulation of the vagus nerve by an implanted electrode. US Patent Application publication number 2006/0229677 to Moffitt et al. describes transvascularly stimulating a nerve trunk through a blood vessel. None of these publications teach or suggest non-invasive stimulation of the inflammatory reflex, including the vagus nerve.

Pending US Patent application 2006/0122675 to Libbus et al. describes a vagus nerve stimulator for transcutaneous electrical stimulation that may be placed either behind the ear or in the ear canal. This device is intended to regulate heart rate by vagal stimulation.

Currently available methods of stimulating the vagus nerve, while successful, can have certain disadvantages. For example, pharmacological stimulation carries the risk of undesirable side-effects and adverse drug reactions. Electrical stimulation of the vagus nerve may damage nerve fibers or may lack fiber specificity. Implants for stimulation of the vagus nerve have obvious disadvantages associated with surgery. Finally, even transcutaneous stimulation of the vagus nerve, if not performed in the appropriate body region, will be ineffective for treatment of inflammatory disorders.

Described herein are systems, devices and methods that may address these issues.

### SUMMARY OF THE INVENTION

Described herein are devices, systems and method of non-invasively stimulating a subject's inflammatory reflex to inhibit or control inflammation. Devices and systems may include an actuator to apply non-invasive stimulation and a driver to control the stimulation in a manner that inhibits the inflammatory reflex. The devices may be hand-held or may be wearable. For example, one variation of a stimulator provides a mechanism to mechanically stimulate the aricular vagus afferents. The devices or systems may include an alert or alarm that signals or otherwise indicates that stimulation will be applied, thereby insuring that device is properly applied to the patient for treatment. The systems and devices described herein may also include a controller that adjusts the treatment based upon user compliance and/or feedback. In some variations, the devices or systems also record the treatment parameters and/or transmit treatment parameters, so that they may be reported to a clinician.

In general, the methods of inhibiting the inflammatory reflex described herein may include methods of treating a disorder (e.g., an inflammatory disorder) by stimulating the inflammatory reflex in a manner that significantly inhibits the inflammatory reflex. For example, a method of treating an inflammatory disorder may include the step of non-invasively stimulating a subject's inflammatory reflex in a manner that significantly reduces proinflammatory cytokines in the subject.

The non-invasive stimulation may include mechanical stimulation of a body region such as the subject's ear. In particular, the cymba conchae region of their ear may be stimulated. Appropriate non-invasive stimulation may be limited to a range or mechanical stimulation. For example, the non-invasive stimulation may comprise mechanical stimulation between about 50 and 500 Hz. In some variations the stimulation is transcutaneous stimulation applied to the appropriate body region (e.g., the ear). For example, transcutaneous stimulation may be applied for an appropriate duration (e.g., less than 5 minutes, less than 1 minute, etc.), at an appropriate intensity and frequency. Stimulation that does not significantly affect cardiac measures may be particularly desirable, and the stimulation may be limited to such a range, or may be regulated by cardiac feedback (e.g., ECG, etc.).

The non-invasive duration of the non-invasive stimulation may be particularly short. For example, the stimulation may be less than 10 minutes, less than 5 minutes, less than 3 minutes, or less than 1 minute. Prolonged and/or continuous stimulation may result in desensitization of the inhibitory effect on the inflammation reflex. Thus, in some variation the methods are limited to simulation for less than an amount of time before significant desensitization occurs. A specific threshold for desensitization may be determined for an individual prior to starting a treatment, or a general threshold (e.g., based on population data or experiment) may be used.

One (non-limiting) theory for the effect of inhibition on the inflammatory reflex by non-invasive stimulation (particularly in regions such as the cymba conchae of the ear) hypothesized that the stimulation of mechanoreceptors, and particularly Pacinian corpuscles, result in stimulation of a nerve of the inflammatory reflex such as the vagus nerve, and thereby inhibits the inflammatory reflex, resulting in a decrease in cytokines and cellular markers for inflammation. Thus, in some variations the stimulation applied may comprise a temporal pattern that does not allow accommodation of mechanoreceptors (e.g., Pacinian corpuscles) in the region of stimulation during the stimulation period. For example, the non-invasive stimulation may be mechanical stimulation at a varying and/or irregular frequency between about 50 and 500 Hz.

For example, the non-invasive stimulation may comprise mechanical stimulation of the subject's cymba conchae region of their ear for between about 50 and 500 Hz for about one minute.

Other regions of the subject's body may be alternatively or additional stimulated, particularly regions enervated by nerves of the inflammatory reflex. For example, the non-invasive stimulation may be applied to the subject's area innervated by the seventh (facial) cranial nerve or cranial nerve V. The non-invasive stimulation may be applied to at least one location selected from: the subject's cymba conchae of the ear, or helix of the ear. In some variations, the non-invasive stimulation is applied to at least one point along the spleen meridian.

The methods of treating inflammatory disorders described herein may be applied (and/or modified) to treat any inflammatory disorder, including, but not limited to: appendicitis, peptic ulcer, gastric ulcer, duodenal ulcer, peritonitis, pancreatitis, ulcerative colitis, pseudomembranous colitis, acute colitis, ischemic colitis, diverticulitis, epiglottitis, achalasia, cholangitis, cholecystitits, hepatitis, Crohn's disease, enteritis, Whipple's disease, allergy, anaphylactic shock, immune complex disease, organ ischemia, reperfusion injury, organ necrosis, hay fever, sepsis, septicemia, endotoxic shock, cachexia, hyperpyrexia, eosinophilic granuloma, granulomatosis, sarcoidosis, septic abortion, epididymitis, vaginitis, prostatitis, urethritis, bronchitis, emphysema, rhinitis, pneumonitits, pneumotransmicroscopic silicovolcanoconiosis, alvealitis, bronchiolitis, pharyngitis, pleurisy, sinusitis, influenza, respiratory syncytial virus infection, HIV infection, hepatitis B virus infection, hepatitis C virus infection, disseminated bacteremia, Dengue fever, candidiasis, malaria, filariasis, amebiasis, hydatid cysts, burns, dermatitis, dermatomyositis, sunburn, urticaria, warts, wheals, vasulitis, angiitis, endocarditis, arteritis, atherosclerosis, thrombophlebitis, pericarditis, myocarditis, myocardial ischemia, periarteritis nodosa, rheumatic fever, Alzheimer's disease, coeliac disease, congestive heart failure, adult respiratory distress syndrome, meningitis, encephalitis, multiple sclerosis, cerebral infarction, cerebral embolism, Guillame-Barre syndrome, neuritis, neuralgia, spinal cord injury, paralysis, uveitis, arthritides, arthralgias, osteomyelitis, fasciitis, Paget's disease, gout, periodontal disease, rheumatoid arthritis, synovitis, myasthenia gravis, thyroiditis, systemic lupus erythematosis, Goodpasture's syndrome, Behcet's syndrome, allograft rejection, graft-versus-host disease, Type I diabetes, Type II diabetes, ankylosing spondylitis, Berger's disease, Reiter's syndrome, Hodgkin's disease, ileus, hypertension, irritable bowel syndrome, myocardial infarction, sleeplessness, anxiety and stent trombosis. In some variations the inflammatory disorder is rheumatoid arthritis.

Also described herein are methods of treating an inflammatory disorder comprising non-invasively stimulating a subject's ear to stimulate the inflammatory reflex in a manner that significantly reduces the proinflammatory cytokines in the subject. Any of the steps described above may be applied to this method. For example, the non-invasive stimulation may include mechanical stimulation of the subject's cymba conchae region of their ear, and the stimulation may be performed between about 50 and 500 Hz.

Also described herein are methods of treating an inflammatory disorder comprising mechanically stimulating a subject's ear to stimulate the inflammatory reflex in a manner that significantly reduces the proinflammatory cytokines in the subject. Any of the steps described above may be applied to this method.

Also described herein are methods of treating an inflammatory disorder comprising mechanically stimulating a subject's cymba conchae region of the ear for less than five minutes in a manner that significantly reduces the proinflammatory cytokines in the subject. Any of the steps described above may be applied to this method.

Also described herein are devices for non-invasively stimulating a subject's inflammatory reflex, which may be referred to herein as “stimulation devices”. These devices may include an actuator, such as a movable distal tip region that is configured to mechanically stimulate at least a portion of a subject's ear, a handle, and a driver configured to move the distal tip region between about 50 and 500 Hz. In some variations, the stimulation devices are part of a system including a stimulation device.

A stimulation device may include a controller configured to control the driver so that it applies stimulation within stimulation parameters. For example the controller (which may be part of the driver, or may be separate from the driver) may control the intensity (e.g., force, displacement, etc.), the timing and/or frequency (e.g., the frequency of repeated pulses during a stimulation period, the stimulation duration during the period of stimulation, the duration between stimulation periods, etc.), or the like. In some variations the controller is pre-programmed. In some variations, the controller receives input. The input may be control input (e.g., from a physician or the patient) that modifies the treatment. In some variation the device receives feedback input based on measurements or analysis of the patient's response to the stimulation. For example, the controller may receive an index of heart rate variability, a cytokine level estimate or index, or the like. The stimulation may be modified based on these one or more inputs. In some variations the stimulator device includes a therapy timer configured to limit the duration of stimulation.

For example, the controller may be configured to limit the period of stimulation to less than 10 minutes, less than 5 minutes, less than 3 minutes, less than 1 minute, etc. In some variations, the stimulator limits the time between stimulation periods to greater than 1 hour, greater than 2 hours, greater than 4 hours, greater than 8 hours, greater than 12 hours, greater than 24 hours, or greater than 48 hours, etc.

Any appropriate driver may be used. For example, the driver may be a motor, voice (or speaker) coil, electromagnet, bimorph, piezo crystal, electrostatic actuator, and/or rotating magnet or mass.

For example, in some variations the driver is a mechanical driver that moves an actuator against the subject's skin. Thus, an actuator may be a distal tip region having a diameter of between about 35 mm and about 8 mm.

In some variation the stimulator includes a frequency generator that is in communication with the driver. Thus the driver may control the frequency generator to apply a particular predetermined frequency or range of frequencies to the actuator to non-invasively stimulate the subject.

The stimulator devices described herein may be hand-held or wearable. For example, also described herein are wearable device for non-invasively stimulating a subject's inflammatory reflex. These stimulator the devices may include an actuator configured to mechanically stimulate a subject's cymba conchae, a driver configured to move the distal tip region between about 50 and 500 Hz, and an ear attachment region configured to secure to at least a portion of a subject's ear.

Any of the stimulator devices described herein for non-invasively stimulating the subject's ear may also include one or more alerts (outputs) to let the subject or a clinician know to apply the device to the subject. Since the time between stimulation periods may be particularly long (as described above) for the low and very low duty-cycle stimulation described, an alert may be particularly useful. An alert may include an audible alert (e.g., beeping, ringing, voice message, etc.) and/or it may include a visible alter (e.g., flashing light, color indicator, etc.), a tactile alert (vibrating, etc.), or some combination thereof.

Any of the stimulation devices described herein may also be configured to record or transmit treatment information on the operation of the device. For example, the devices may indicate that they successfully (or unsuccessfully) non-invasively stimulated a subject. In some variations the devices may also record information or data from the subject, such as heart rate parameters, immune response parameters, or the like. Thus, a device may include a memory for storing information or data on treatment. In some variations the device also includes a processor for processing such information (including partially or completely analyzing it). The information may be used to modify the treatment. These devices may also include communications components that allow the devices to communicate with a physician or outside network or device. For example, the device may be capable of wirelessly (or via connection of wire) communication with a device or server. Information about the treatment may be sent from the stimulator device for analysis by the doctor, or for automatic analysis. In some variations the devices may also receive information and/or instructions from an outside device or server. For example, the devices may receive information (feedback) on immune response parameters tested by blood draw. This information may be used to modify the treatment.

As mentioned above, the wearable stimulator device may include any appropriate actuator, including (but not limited to) an: electromagnet, bimorph, piezo crystal, electrostatic actuator, speaker coil, and rotating magnet or mass. In some variations the stimulator device also includes a driver circuit for controlling the amplitude, frequency, and duty cycle of the driver. The driver circuit may also include a timer (e.g., a therapy timer configured to limit the duration of stimulation, etc.).

The devices may be powered by any appropriate source, including battery power. For example, the wearable devices may be powered by a battery appropriate for a hearing aid.

### INCORPORATION BY REFERENCE

All publications and patent applications mentioned in this specification are herein incorporated by reference in their entirety to the same extent as if each individual publication or patent application was specifically and individually indicated to be incorporated by reference.

### BRIEF DESCRIPTION OF THE DRAWINGS

FIG. 1 is a depiction of a human ear, showing possible locations of vagal stimulation.

FIGS. 2A and 2B are depictions of facial enervation, showing the seventh (facial) cranial nerve and auricular branch of the vagus nerve, respectively.

FIG. 3A and FIG. 3B show the acupuncture points located along the “spleen meridian” which can be the sites for non-invasive stimulation of the vagus nerve in the spleen.

FIG. 4 is a bar plot showing attenuation of serum TNF levels during lethal endotoxemia in mice following non-invasive mechanical cervical stimulation of the inflammatory reflex.

FIG. 5 is a bar plot showing attenuation of serum HMGB1 levels in septic mice following non-invasive mechanical cervical stimulation.

FIG. 6 is a bar plot showing clinical scores of septic mice following non-invasive mechanical cervical stimulation.

FIG. 7 is a plot showing survival rates of septic mice subjected to the non-invasive mechanical cervical stimulation of the inflammatory reflex.

FIG. 8 shows the percent change in high frequency power (HF Power) in a group of 6 subjects who received external auricular stimulation of the inflammatory reflex.

FIG. 9 shows the normalized percent change in high frequency power (HF Power) in a group of 6 subjects who received external auricular vagal stimulation of the inflammatory reflex.

FIG. 10 shows the percent change in high frequency power (HF Power) averaged over a group of 6 subjects who received external auricular vagal stimulation of the inflammatory reflex.

FIG. 11 is a table presenting data on instantaneous heart rate variability from six subjects (A through F), derived from standardized software (CardioPro™) before and after non-invasive stimulation of a subject's inflammatory reflex.

FIG. 12 is the morning percent-change in heart rate variability (high frequency) following auricular non-invasive stimulation of the inflammatory reflex in a rheumatoid arthritis subject and in a healthy control.

FIG. 13 is the evening percent-change in heart rate variability (high frequency) following non-invasive auricular stimulation of the inflammatory reflex in a rheumatoid arthritis subject and in a healthy control.

FIG. 14 is a table of the clinical scores of a rheumatoid arthritis subject who received auricular non-invasive mechanical stimulation of the inflammatory reflex.

FIG. 15 graphically depicts the effect of non-invasive vagal stimulation of the inflammatory reflex in human subjects on TNFα.

FIG. 16 graphically depicts the effect of non-invasive stimulation of the inflammatory reflex in human subjects on IL-1β.

FIG. 17 graphically depicts the effect of non-invasive stimulation of the inflammatory reflex in human subjects on IL-6.

FIG. 18 graphically depicts the effect of non-invasive stimulation of the inflammatory reflex in human subjects on IL-8.

FIG. 19 graphically depicts the effect of non-invasive stimulation of the inflammatory reflex in human subjects on IL-10.

FIG. 20 graphically depicts the effect of non-invasive stimulation of the inflammatory reflex in human subjects on a cellular marker for inflammation, monocyte HLA-DR.

FIG. 21 illustrates that non-invasive stimulation of the inflammatory reflex via the ear does not significantly affect cardiac measures including heart rate and tone.

FIG. 22 is a table summarizing the effect of non-invasive stimulation of the inflammatory reflex via the ear on test subjects.

FIG. 23 is a schematic diagram illustrating one variation of a driver circuit for a non-invasive stimulator.

FIGS. 24A-24C are different variations of mechanical stimulation heads.

FIG. 25 is one variation of a mechanical stimulator for the inflammatory reflex.

FIG. 26 is another variation of a mechanical stimulator for the inflammatory reflex.

FIG. 27 is another variation of a mechanical stimulator for the inflammatory reflex.

FIG. 28A shows a mechanical stimulation system that may be worn on an ear to modulate the inflammatory reflex, FIG. 28B shows one component of the stimulator of FIG. 28A, and FIG. 28C shows a side cross-sectional view of the system of FIG. 28A.

FIG. 29A shows another variation of a mechanical stimulations system that may be worn on an ear to modulate the inflammatory reflex, and FIG. 29B illustrates the device when worn in an ear.

FIG. 30A shows schematic illustration of a device for non-invasively modulating the inflammatory reflex, and FIG. 30B is a variation of a mechanical stimulator that may be worn on an ear to modulate the inflammatory reflex. FIG. 30C shows a perspective view of another variation of a mechanical stimulator, and FIG. 30D illustrates the device of FIG. 30B when worn on an ear.

FIGS. 31A and 31B show another variation of a non-invasive stimulator, similar to the device shown in FIGS. 30A-30B. FIG. 31A is a schematic illustrating the device, and FIG. 31B shows a perspective view of the device.

### DETAILED DESCRIPTION OF THE INVENTION

Appropriate non-invasive stimulation may inhibit the inflammatory reflex. In particular, appropriate non-invasive stimulation may reduce the levels of one or more proinflammatory cytokines in a subject. For example, non-invasive stimulation may be mechanical stimulation applied to the subject's ear or other body region. Described herein are methods, devices and systems for non-invasive stimulation to inhibit the inflammatory reflex.

In general, a device for non-invasively stimulation of the inflammatory reflex (e.g., the vagus nerve) may include an actuator configured to contact the patient, a driver configured to drive the actuator at an appropriate frequency (and/or duration, duty cycle, and force). The device may be hand-held or it may be wearable. As described in greater detail below, the driver may include, or may be connected to a controller, that includes a timer to regulate the application of stimulation by the device, and these devices may also include memory or other features for monitoring, storing and/or transmitting data about the application of stimulation.

The inflammatory reflex includes the neurophysiological mechanisms that regulate the immune system. The efferent branch of the reflex includes the cholinergic anti-inflammatory pathway, which inhibits inflammation by suppressing cytokine synthesis via release of acetylcholine in organs of the reticuloendothelial system, including the spleen, liver, and gastrointestinal tract. Acetylcholine, in turn, binds to nicotinic acetylcholine receptors expressed by macrophages and other cytokine-producing cells.

The inflammatory reflex therefore includes nerve afferents and nerve efferents that contribute to this pathway. For example, stimulation of nerves in the base of the skull may trigger the inflammatory reflex. Nerves that form part of the inflammatory reflex may include the vagus nerve, the splenic nerve, the hepatic nerve, the facial nerve, and the trigeminal nerve. References to these nerves (i.e., the “vagus nerve”) are used in the broadest sense, and may include any nerves that branch off from the main nerve (i.e., the main vagus nerve), as well as ganglions or postganglionic neurons that are connected to the nerve. The vagus nerve is also known in the art as the parasympathetic nervous system and its branches, and the cholinergic nerve. The vagus nerve enervates principal organs including, the pharynx, the larynx, the esophagus, the heart, the lungs, the stomach, the pancreas, the spleen, the kidneys, the adrenal glands, the small and large intestine, the colon, and the liver. Activation can be accomplished by stimulation of the nerve or an organ served by the nerve. For example, activation or stimulation of the inflammatory reflex may mean stimulating a nerve of the inflammatory reflex or an organ enervated by the inflammatory reflex or that otherwise results in activation/stimulation of a nerve of the inflammatory reflex such as the vagus nerve.

“Non-invasive stimulation” typically means stimulation that does not require a surgery, exposure of the nerve fiber or direct contact with the nerve fiber. As used herein, “non-invasive stimulation” also does not include administration of pharmacological agents. For example, non-invasive vagus nerve stimulation can be achieved, for example, by mechanical (e.g., vibration) or electrical (e.g. electromagnetic radiation) means applied externally to the subject.

A “patient” or “subject” is preferably a mammal, more preferably a human subject but can also be a companion animal (e.g., dog or cat), a farm animal (e.g., horse, cow, or sheep) or a laboratory animal (e.g., rat, mouse, or guinea pig). Preferable, the subject is human.

The term “therapeutically effective amount” typically means an amount of the stimulation which is sufficient to reduce or ameliorate the severity, duration, progression, or onset of inflammation or an inflammatory disorder, prevent the advancement of an inflammatory disorder, cause the regression of an inflammatory disorder, prevent the recurrence, development, onset or progression of a symptom associated with an inflammatory disorder, or enhance or improve the prophylactic or therapeutic effect(s) of another therapy. The precise amount (duration, intensity and the like) of stimulation administered to a subject will depend on the mode of administration, the type and severity of the disease or condition and on the characteristics of the subject, such as general health, age, sex, body weight and tolerance to drugs. The skilled artisan will be able to determine appropriate dosages depending on these and other factors.

“Stimulating the inflammatory reflex of the subject in a manner that significantly reduces proinflammatory cytokines” means providing an amount of stimulation at such a location on a subject and in such a manner as to significantly reduce proinflammatory cytokines in the subject. The stimulation (e.g., mechanical, non-invasive stimulation) may stimulate the inflammatory reflex (e.g., nerves of the inflammatory reflex) either directly (so that the stimulation is felt by a nerve of the inflammatory reflex) or indirectly (so that the stimulation is detected by an accessory or downstream nerve that communicates with a nerve of the inflammatory reflex).

“Treatment” includes prophylactic and therapeutic treatment. “Prophylactic treatment” refers to treatment before onset of an inflammatory condition to prevent, inhibit or reduce its occurrence. Therapeutic treatment is treatment of a subject that is already experiencing an inflammatory disorder.

A therapeutically effective treatment may include stimulation of a subject in a therapeutically effective amount to achieve at least a small but measurable reduction in the subject's symptoms and/or cause of the disorder being treated.

Inflammatory disorders may include disorders and diseases mediated by an inflammatory cytokine cascade, defined herein as an in vivo release from cells of at least one proinflammatory cytokine in a subject, wherein the cytokine release affects a physiological condition of the subject. Non-limiting examples of cells that produce proinflammatory cytokines are monocytes, macrophages, neutrophils, epithelial cells, osteoblasts, fibroblasts, smooth muscle cells, and neurons. The condition can be one where the inflammatory cytokine cascade causes a systemic reaction, such as with septic shock. Alternatively, the condition can be mediated by a localized inflammatory cytokine cascade, as in rheumatoid arthritis. Inflammatory disorders can also include disorders and diseases modulated by the effector cells such as lymphocytes, neutrophils, mast cells, monocytes, macrophages, platelets, and all other cells present in blood that pass through the spleen. Inflammatory disorders can also include disorders and diseases modulated by molecules other than cytokines (e.g. acute phase proteins, lipids, or glycoproteins). Inflammatory disorders also include disorders and diseases modulated by the dis-balance of the pro- and anti-inflammatory cytokines. Also included are disorders and diseases that may have an inflammatory component or are caused by an inflammatory process.

A cytokine is a soluble protein or peptide which is naturally produced by mammalian cells and which act in vivo as humoral regulators at micro- to picomolar concentrations. Cytokines can, either under normal or pathological conditions, modulate the functional activities of individual cells and tissues. A proinflammatory cytokine is a cytokine that is capable of causing any of the following physiological reactions associated with inflammation: vasodialation, hyperemia, increased permeability of vessels with associated edema, accumulation of granulocytes and mononuclear phagocytes, or deposition of fibrin. In some cases, the proinflammatory cytokine can also cause apoptosis, such as in chronic heart failure, where TNF has been shown to stimulate cardiomyocyte apoptosis. Non-limiting examples of proinflammatory cytokines are tumor necrosis factor (TNF), interleukin (IL)-1α, IL-1.beta., IL-6, IL-8, IL-18, interferon γ, HMG-1, platelet-activating factor (PAF), and macrophage migration inhibitory factor (MIF). In preferred embodiments of the invention, the proinflammatory cytokine that is inhibited by the vagus nerve stimulation are TNF, an IL-1, IL-6 or IL-18, because these cytokines are produced by macrophages and mediate deleterious conditions for many important disorders, for example endotoxic shock, asthma, rheumatoid arthritis, inflammatory bile disease, heart failure, and allograft rejection. In most preferred embodiments, the proinflammatory cytokine is TNF.

Proinflammatory cytokines are to be distinguished from anti-inflammatory cytokines, such as IL-4, IL-10, and IL-13, which are not believed to be mediators of inflammation. In preferred embodiments, release of anti-inflammatory cytokines is not inhibited by the non-invasive stimulation to inhibit the inflammatory reflex.

### Methods of Inhibiting the Inflammatory Reflex

The inflammatory reflex, including the vagus nerve, may be non-invasively stimulated to provide a therapeutically effective treatment for a subject. The inflammatory reflex can be non-invasively stimulated in a manner that significantly reduces the level of one or more proinflammatory cytokines in the subject. The reduction may be long-lasting, and may be repeated after a delay period in order to sustain the reduction. The manner of stimulation may be the application of mechanical stimulation (e.g., pressure or force) to a region of the body that either directly or indirectly stimulates the inflammatory reflex. The stimulation may have characteristics (e.g., the duration, intensity, frequency, duty cycle, etc.) selected to optimize the non-invasive stimulatory effects.

### Location of Stimulation

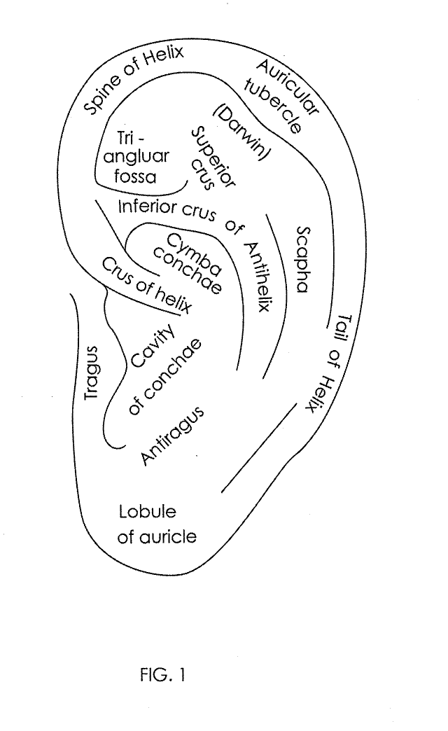

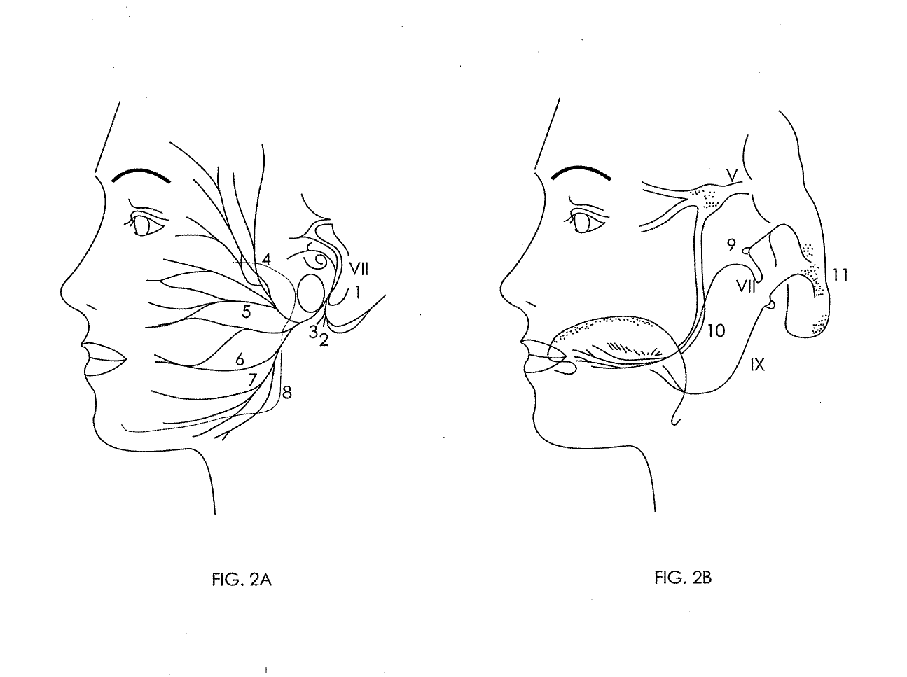

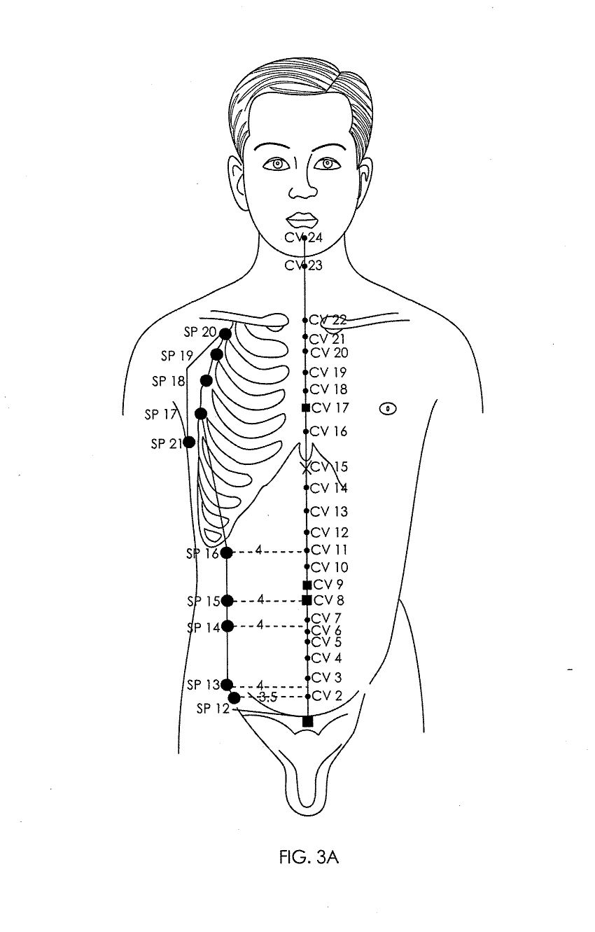

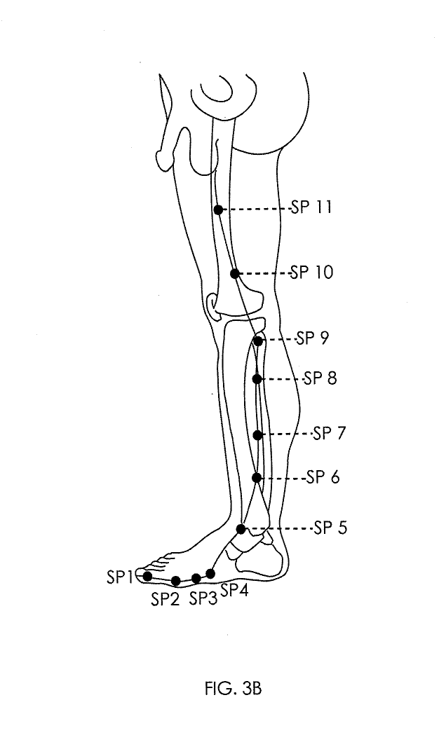

The inflammatory reflex may be non-invasively stimulated in a therapeutically effective locus. In one embodiment, the non-invasive stimulation can be applied to the subject's ear, or a particular region of the subject's ear. See FIG. 1. For example, non-invasive stimulation can be applied to the subject's pinna of the ear (auricle), specifically, to the cymba conchae of the ear, or helix of the ear. Preferably, the non-invasive stimulation is applied to the cymba conchae of the ear. In one embodiment, the non-invasive stimulation is applied to an area of the subject innervated by the seventh (facial) cranial nerve, which is illustrated in FIG. 2. In another embodiment, the non-invasive stimulation is applied to an area of the subject innervated by the cranial nerve V. In another embodiment, the non-invasive stimulation is applied at the acupuncture points along the so called “spleen meridian”, shown in FIG. 3A and FIG. 3B.

Preferably, the non-invasive stimulation of the inflammatory reflex is not performed in a manner and/or at a location that may raise the risk of an adverse medical condition. An example of such undesirable manner/location is cervical massage of the vagus nerve, which is performed in a location adjacent to the carotid artery and/or carotid body (an organ responsible for monitoring arterial blood pressure). Although non-invasive stimulation at this location can be effective for treating an inflammatory disorder, such stimulation may raise the risk of stroke. Accordingly, the non-invasive stimulation may be understood to mean excluding such regions. For example non-invasive stimulation may exclude a cervical massage. In another embodiment, the non-invasive stimulation is not performed in a location adjacent to the carotid artery of the subject. In yet another embodiment, the non-invasive stimulation is not performed on the neck of the subject. In some variations, however, the non-invasive stimulation may be performed in such high-risk areas, but the stimulation may be limited in intensity, duration, frequency and the like, so that it has a therapeutic effect on the inflammatory disorder without triggering an adverse medical condition.

In some variations, non-invasive stimulation of the inflammatory reflex can be accomplished by stimulation of the vagus nerve proper or by stimulating an organ served by the vagus nerve. For example, a site of stimulation of the vagus nerve can be in supra-diaphragmatical or sub-diaphragmatical regions. Peripheral, distal locations include branches of the vagus nerve that innervate the organs, including but not limited to, the spleen, the small intestine and the large intestine.

The non-invasive stimulation of the inflammatory reflex may be acting though a receptor such as a mechanoreceptor that communicates with a nerve of the inflammatory reflex. For example, a mechanoreceptor such as a Pacinian corpuscle, which is a mechanoreceptor that is particularly well suited to receiving high-frequency and deep pressure mechanical stimulation. Thus, in some variations, the non-invasive stimulation may be appropriate to stimulation to activate a Pacinian corpuscle. The devices, systems and methods described herein are not limited to this theory of operation, however. Alternatively or additionally, non-invasive stimulation may act directly on a nerve such as the vagus nerve may activate the nerve through the pressure or force felt by the vagus nerve or a neuron or nerve in communication with the vagus nerve.

### Types of Non-Invasive Stimulation

In general, the non-invasive stimulation described herein is non-invasive mechanical stimulation applied at a predetermined range of intensities, frequencies, and duty-cycles. However, other types of non-invasive stimulation may also be used (e.g. non-invasive electrical stimulation).

Mechanical stimulation may be oscillatory, repeated, pulsatile, or the like. In some variations the non-invasive stimulation may the repeated application of a mechanical force against the subject's skin at a predetermined frequency for a predetermined period of time. For example, the non-invasive mechanical stimulation may be a mechanical stimulation with a spectral range from 50 to 500 Hz, at an amplitude that ranges between 0.0001-5 mm displacement. The temporal characteristics of the mechanical stimulation may be specific to the targeted disease. In some variations the frequency of stimulation is varying or non-constant. The frequency may be varied between 50 and 500 Hz. In some variations the frequency is constant. In general the frequency refers to the frequency of the pulsatile stimulation within an “on period” of stimulation. Multiple stimulation periods may be separated by an “off period” extending for hours or even days, as mentioned above.

The force with which the mechanical stimulation is applied may also be constant, or it may be variably. Varying the force and/or frequency may be beneficial to ensure that the mechanical stimulation is effective during the entire period of stimulation, particularly if the effect of non-invasive stimulation operates at least in part through mechanoreceptors such as the rapidly acclimating Pacinian corpuscles.

### Treatments

Non-limiting examples of inflammatory disorders which can be treated using the present invention include appendicitis, peptic ulcer, gastric ulcer, duodenal ulcer, peritonitis, pancreatitis, ulcerative colitis, pseudomembranous colitis, acute colitis, ischemic colitis, diverticulitis, epiglottitis, achalasia, cholangitis, cholecystitits, hepatitis, Crohn's disease, enteritis, Whipple's disease, allergy, anaphylactic shock, immune complex disease, organ ischemia, reperfusion injury, organ necrosis, hay fever, sepsis, septicemia, endotoxic shock, cachexia, hyperpyrexia, eosinophilic granuloma, granulomatosis, sarcoidosis, septic abortion, epididymitis, vaginitis, prostatitis, urethritis, bronchitis, emphysema, rhinitis, pneumonitits, pneumoultramicroscopic silicovolcanoconiosis, alvealitis, bronchiolitis, pharyngitis, pleurisy, sinusitis, influenza, respiratory syncytial virus infection, HIV infection, hepatitis B virus infection, hepatitis C virus infection, herpes virus infection disseminated bacteremia, Dengue fever, candidiasis, malaria, filariasis, amebiasis, hydatid cysts, burns, dermatitis, dermatomyositis, sunburn, urticaria, warts, wheals, vasulitis, angiitis, endocarditis, arteritis, atherosclerosis, thrombophlebitis, pericarditis, myocarditis, myocardial ischemia, periarteritis nodosa, rheumatic fever, Alzheimer's disease, coeliac disease, congestive heart failure, adult respiratory distress syndrome, meningitis, encephalitis, multiple sclerosis, cerebral infarction, cerebral embolism, Guillame-Barre syndrome, neuritis, neuralgia, spinal cord injury, paralysis, uveitis, arthritides, arthralgias, osteomyelitis, fasciitis, Paget's disease, gout, periodontal disease, rheumatoid arthritis, synovitis, myasthenia gravis, thyroiditis, systemic lupus erythematosis, Goodpasture's syndrome, Behcet's syndrome, allograft rejection, graft-versus-host disease, Type I diabetes, Type II diabetes, ankylosing spondylitis, Berger's disease, Reiter's syndrome, Hodgkin's disease, ileus, hypertension, irritable bowel syndrome, myocardial infarction, sleeplessness, anxiety and stent trombosis.

In more preferred embodiments, the condition is appendicitis, peptic, gastric or duodenal ulcers, peritonitis, pancreatitis, ulcerative, pseudomembranous, acute or ischemic colitis, hepatitis, Crohn's disease, asthma, allergy, anaphylactic shock, organ ischemia, reperfusion injury, organ necrosis, hay fever, sepsis, septicemia, endotoxic shock, cachexia, septic abortion, disseminated bacteremia, burns, Alzheimer's disease, coeliac disease, congestive heart failure, adult respiratory distress syndrome, cerebral infarction, cerebral embolism, spinal cord injury, paralysis, allograft rejection, graft-versus-host disease, ileus or stent trombosis. In some embodiments, the condition is endotoxic shock or ileus.

In another preferred embodiment, the conditions are sepsis, endotoxic shock, allograft rejection, rheumatoid arthritis, adult respiratory distress syndrome, asthma, systemic lupus erythematosis, pancreatitis, peritonitis, burns, myocardial ischemia, allograft rejection, graft-versus-host disease, congestive heart failure, organ ischemia, reperfusion injury, cachexia and cystic fibrosis.

In another preferred embodiment, the conditions are appendicitis, ulcerative colitis, Crohn's disease, allergy, reperfusion injury, systemic lupus erythematosus, hepatitis, Behcet's syndrome, multiple sclerosis and atherosclerosis. In another preferred embodiment, the conditions are endotoxic shock and sepsis. In another embodiment, the condition is ileus, hypertension, irritable bowel, myocardial infarction, sleep, or anxiety. In another embodiment, the condition is stent trombosis. In a particularly preferred embodiment, the condition is rheumatoid arthritis.

In performing any of these therapies, the non-invasive stimulation may be scheduled or timed in a specific manner. For example, a period of stimulation (“on stimulation”) may be followed by a period during which stimulation is not applied (“off period”). The off period may be much longer than the on period. For example, the off period may be greater than an hour, greater than two hours, greater than four hours, greater than 8 hours, greater than 12 hours, greater than 24 hours, or greater than 2 days. During the off period, or the period between stimulation “on” periods, the inflammatory reflex may remain suppressed or inhibited. The on period is the duration of a stimulation (which may include a frequency component), and may be less than 10 minutes, less than 5 minutes, less than 2 minutes, less than 1 minute, etc. The ratio of the on period and the off period may partially determine the duty cycle of stimulation. Surprisingly, the stimulation may be extremely low duty cycle and maintain inhibition of the inflammatory reflex.

In some variations, the therapy may include a pre-treatment phase in which the subject's response to the non-invasive stimulation is determined, and used to calibrate the therapy treatment. For example, the location of the non-invasive stimulation may be optimized in a pre-treatment phase by applying non-invasive stimulation to one or more regions and determining a level of inhibition of the inflammatory reflex. Similarly the stimulation characteristics may be tested. For example, the intensity, duration, frequency during stimulation, and/or duty-cycle (on-time/off-time) may be tested. In some variations, a ramp or ramping stimulation in which one or more parameters is varied is applied. The effect (or lack of the effect) of stimulation during the pre-treatment phase may be determined by monitoring on or more markers of inhibition of the inflammatory reflex, including (but not limited to) cytokine levels. The marker levels may be recorded and/or analyzed to determine optimum stimulation parameters. In addition (or alternatively), the methods of treatment may include a step of monitoring one or more markers of the inflammatory reflex following stimulation (immediately or some time thereafter), and may also include feedback to control the stimulation based on the ongoing monitoring.

The inflammatory reflex can be stimulated non-invasively or as a combination of the non-invasive and the invasive procedures. For example, non-invasive stimulation may be paired or alternated with invasive stimulation. In one embodiment in which non-invasive stimulation is combined with an additional invasive stimulation of the vagus nerve, the additional invasive stimulation can be either electrical (e.g., by applying voltage to isolated nerve fibers), mechanical (e.g., by applying a vibrator to an isolated nerve), or by any other means of stimulation known in the art. The additional invasive stimulation can be applied anywhere on the body of the subject, so long as it significantly reduces proinflammatory cytokines in the subject or modulates the inflammatory reflex of the subject in a manner which provides a therapeutically effective treatment for the subject. For example, the vagus nerve may be additionally invasively stimulated, either electrically or mechanically, in the spleen of the subject. Alternative locations for the invasive stimulation, either mechanical or electrical, can include kidney, liver, lung, pancreas, heart, intestines (small and large bowel), rectum, and urinary bladder.

In various embodiments, the vagus nerve can be stimulated by numerous methods including manually, mechanically (e.g. by vibration or acoustically), electrically or by electromagnetic radiation (e.g. radio frequency, ultraviolet radiation, infrared radiation) or by a combination of these methods.

In a preferred embodiment, the non-invasive vagus nerve stimulation is performed mechanically. Mechanical means for stimulating of the inflammatory reflex are described in greater detail below, but exclude stimulation, if any, by a needle such as acupuncture.

### Devices for Non-Invasively Stimulating the Inflammatory Reflex

In general, a device for providing non-invasive stimulation to inhibit the inflammatory reflex includes one or more actuators and a driver. The driver may include a separate or an integral controller that includes control logic for regulating the non-invasive stimulation. The device may also include a mechanism to indicate that the device should be applied to the subject for delivery of treatment. The device may also include components (e.g., memory, logic, processors) for monitoring and/or communicating with an external processor. Thus, the device may record the administration of treatments. The device may also include one or more components (memory, processor, logic, etc.) for adjustment of a treatment based upon patient compliance and/or external input. Thus, in some variations the device may include one or more mechanisms for detecting the application of non-invasive stimulation to the patient. For example, the device may include a force sensor for detecting force against the device during application of non-invasive signature to detect that the device is being properly applied to the subject.

FIG. 23 shows a schematic illustration of one variation of a device for non-invasively stimulating the inflammatory reflex. This example shows a driver (comprising driving circuit) connected to a power source (battery) and driving an actuator, illustrated as an electromagnet or other electro-actuator.

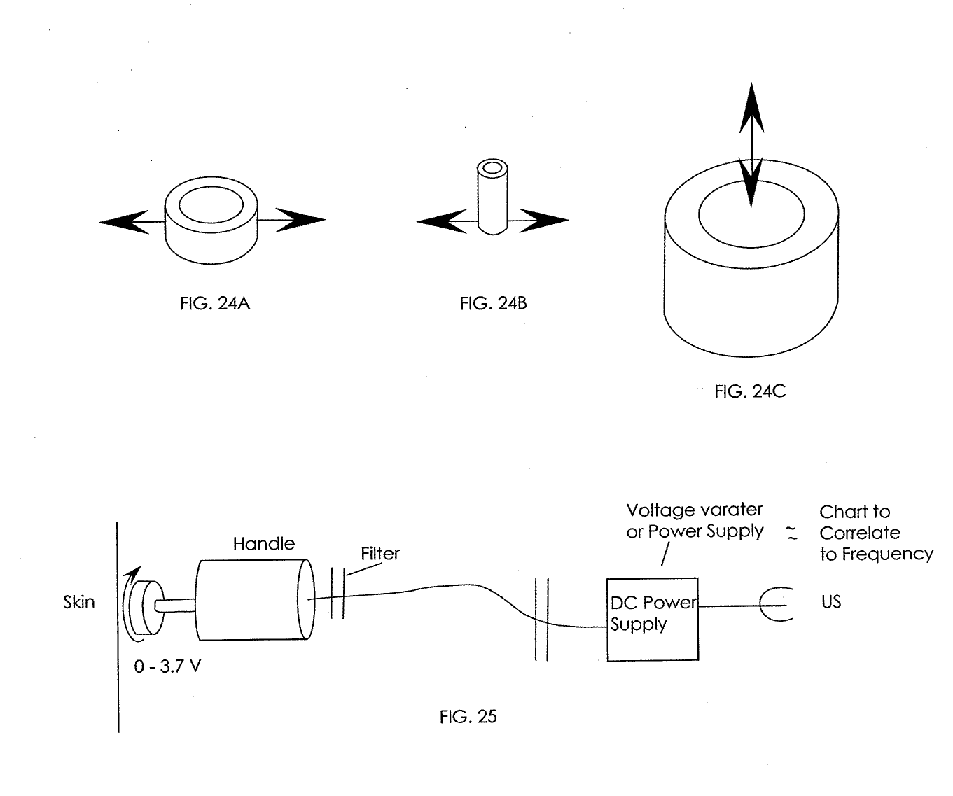

Any appropriate actuator may be used. For example, the actuator may be an electromagnet, a bimorph, a piezo crystal, an electrostatic actuator, a speaker coil, and a rotating magnet or mass. In some variations the actuator is a movable distal tip region. FIGS. 24A to 24C illustrate variations of actuators configured as movable distal tip regions. In these examples the distal tips move primarily in the directions indicated by the arrows. Any appropriate direction of movement may be used. For example in FIG. 24A the distal tip region is a round button-shaped region. In this example the distal tip is approximately 12.5 mm in diameter to 6.25 mm high and round. Non-round shapes (not shown) may also be used. The distal tip region may also be curved rather than flat on the skin-contacting side. In FIG. 24A the distal tip regions moves rotationally in an axial direction, as indicated by the arrows. FIG. 24B shows another variation of an actuator configured as a distal tip that is approximately 8 mm diameter by 23 mm high. FIG. 24C is another variation of a distal tip region having a puck-shaped end. In this example, the distal tip region is approximately 35 mm in diameter by 19 mm high. In all three of these examples, central region of the device is connected to an axel or connector that connects to the driver. One or more sensors (e.g., force or contact sensors) may also be included to detect when the device is applied against the subject.

The outer surface of the actuator may be any appropriate material, particularly materials that are biocompatible such as polymers (e.g., polypropylene, silicones, etc.).

Any appropriate driver may be used to drive the actuator with the appropriate non-invasive stimulation parameters. For example, the driver must be capable of driving the actuator within an appropriate range of force or amplitude (e.g., 0.0001 mm to 5 mm), frequency (e.g., 50-500 Hz), duty cycle (in seconds), and the like. The driver may include a processor or other hardware and/or software that is configured to control the operation of the actuator. In some variations the driver includes a controller. In some variations a separate controller is connected to the driver. The driver and/or controller may include one or more inputs for adjusting the output of the driver. In some variations the driver or controller also includes a clock.

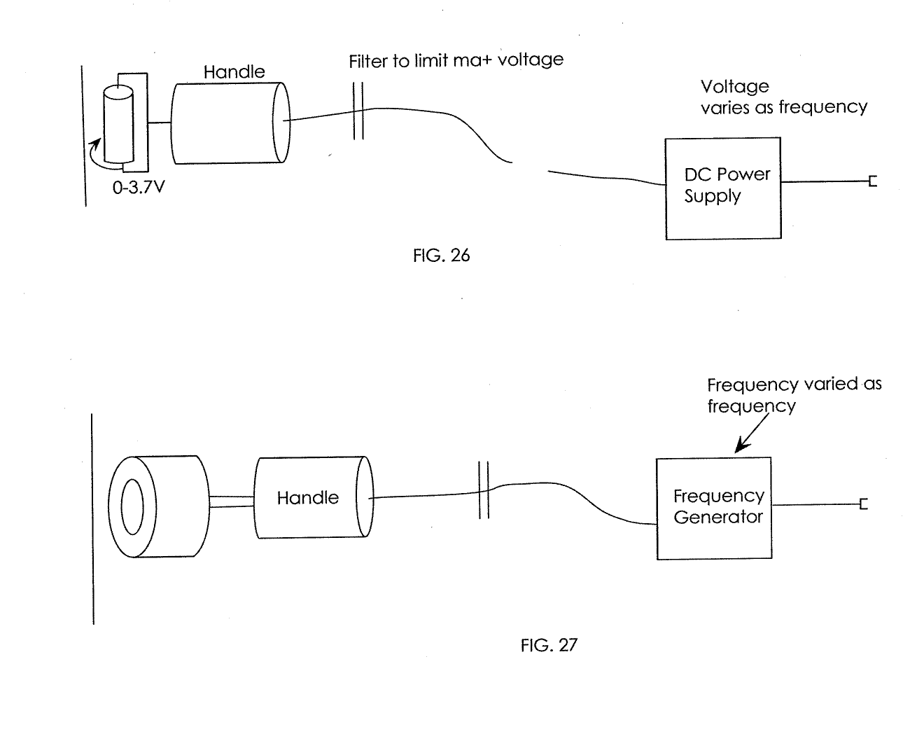

FIGS. 25-27 illustrate different variations of mechanical non-invasive stimulators. In FIG. 27 the mechanical stimulator includes a distal tip actuator the moves in a circular (“massaging”) motion. The actuator is connected to driver that is surrounded by a handle. The driver may be a motor, and in this example is connected to a power supply. The device shown in FIG. 26 show another variation in which the distal tip moves in a sinusoidal motion (“thumping”), but is otherwise similar to FIG. 25. FIG. 27 shows a device in which the actuator region at the distal end moves in and out, and the driver is configured as a voice coil or solenoid which drives the actuator in and out.

The exemplary devices illustrated in FIGS. 25-27 are hand-held devices. As mentioned above, the devices may also be wearable or configured to be worn. A non-invasive stimulator as described herein may be attached or worn by a subject. For example, a non-invasive stimulator may be worn on the subject's ear. A wearable device or system may be lightweight, and may include a battery or batteries. Such devices may also include a memory and/or a communications capability so that the activity of the device can be recorded and/or transmitted. For example, a physician may be able to monitor patient compliance by extracting or receiving data from these devices. Thus, the devices may be configured to include wireless communications capabilities. The device may also include feedback, including one or more sensors, to detect successful delivery of the stimulation to the subject, and/or wearing of the device. Wearable devices may also be programmable, and may receive or modify instructions based on communication with an external controller. Examples of such wearable non-invasive stimulators for inhibiting the inflammatory reflex are described in detail below.

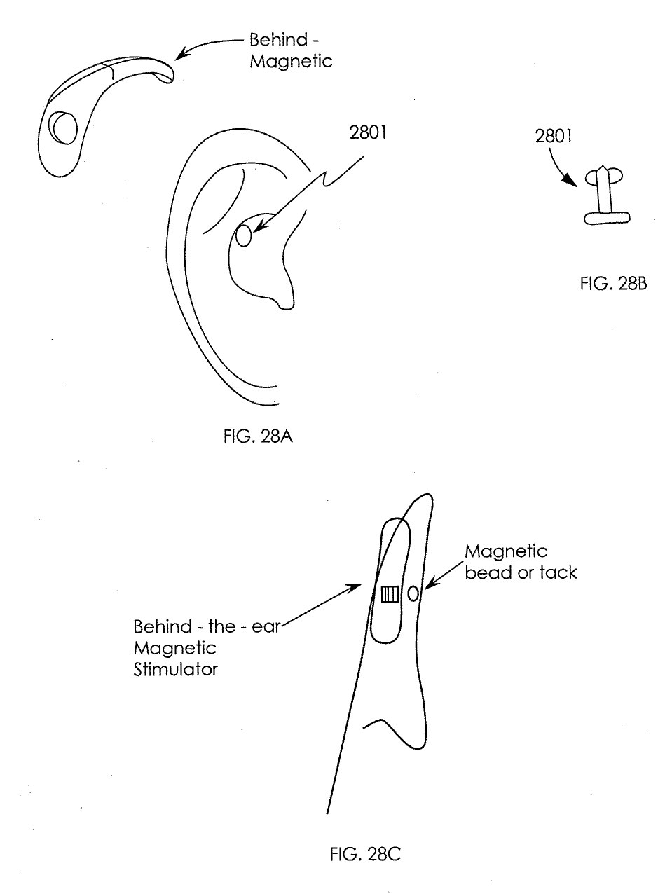

In particular, the devices may be configured to be worn over, on, or in a subject's ear. FIGS. 28A-30D illustrate wearable non-invasive stimulators for non-invasively stimulating a subject's inflammatory reflex. The device or system shown in FIGS. 28A-28C is a “pierced” variation, in which at least a portion of the actuator is worn in the ear.

In FIGS. 28A-28C, a magnetic object (e.g., a magnetic bead or tack) 2801 is embedded in or affixed to the subject's ear in the appropriate region. For example, the magnetic or partially magnetic object 2801 may include a post that pierces the cymba conchae region of the ear. The driver region is included in a housing that fits behind the subject's ear, as shown in FIG. 28A. The driver is a magnetic driver that can provide an alternating electromagnetic field to move the magnetic element against the ear, and thereby non-invasively stimulate the ear. FIG. 28C shows a side view of the system when worn by a subject.

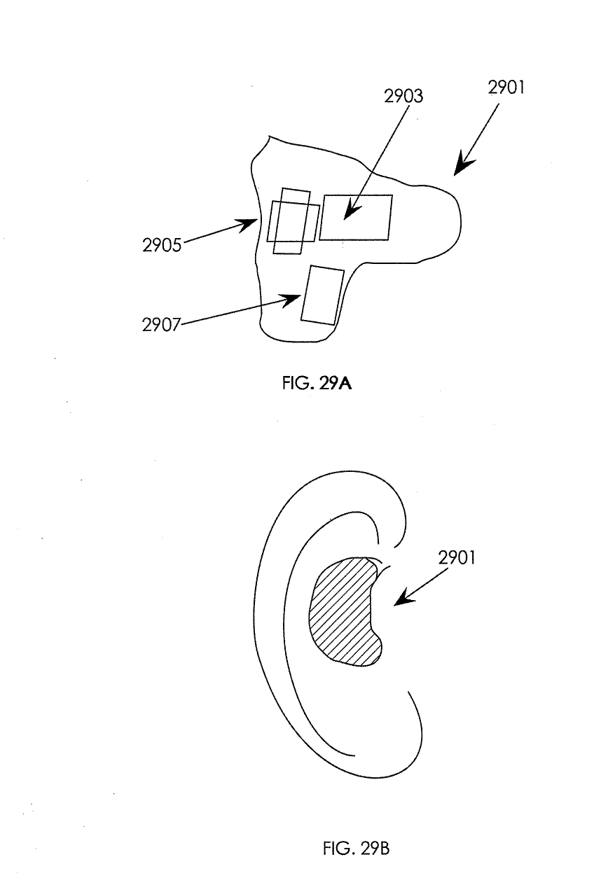

The housing surrounding the driver may be configured (e.g., with a gripping region, a hook region, etc.) to help secure the device behind the subject's ear. The housing may conform to the ear. For example, the housing may be molded to conform to the appropriate region of the ear. FIGS. 29A and 29B show another example of a stimulator 2901 which includes a housing that conforms to the shape of the subject's ear.

FIGS. 29A and 29B show a wearable non-invasive stimulator 2901 for stimulating a subject's inflammatory reflex that includes an actuator (vibrator) 2907 connected by a driver 2903 (including a driver circuit and therapy timer). The housing may be a shell surrounding all or parts of these components. The devices may also include a battery 2905. In some variations the housing is formed by taking a mold of an individual's ear, since each individual's ears may have a different shape or form. The region of the cymba conchae may be indicated on the mold so that the actuator transducer may be positioned in the appropriate region with respect to the cymba conchae when the device is worn, as shown in FIG. 29B.

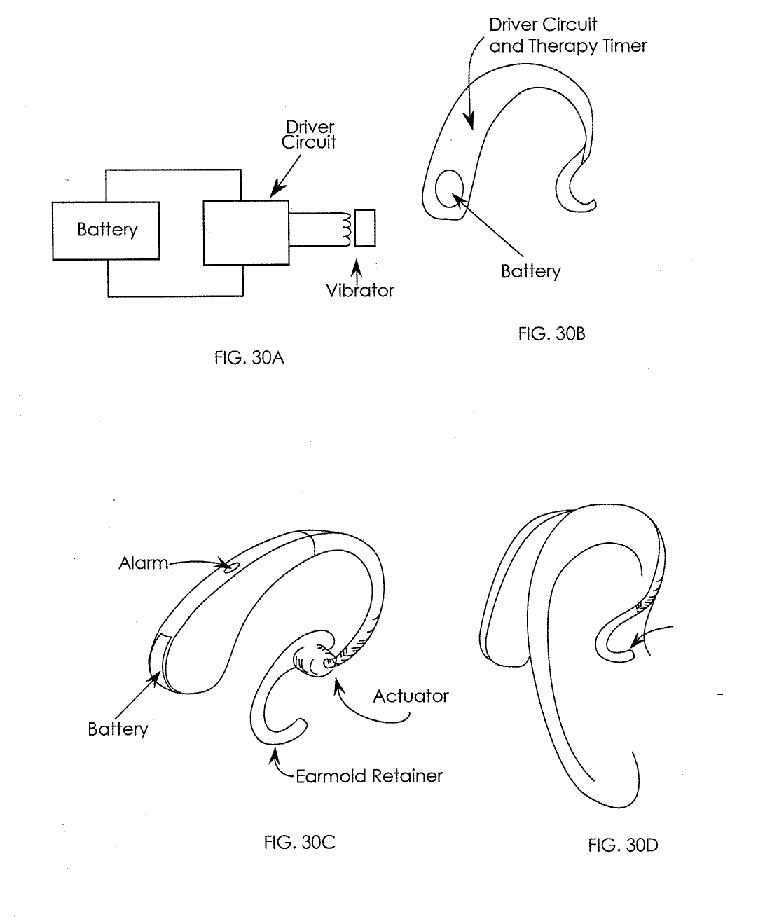

FIGS. 30A-30D illustrate wearable non-invasive stimulation devices that may attach behind the ear and include a projection for contacting the cymba conchae region of the ear. In FIG. 30A the battery and driver circuitry are embedded within the housing in the region behind the ear. A connection region extends around the ear to contact a portion of the cymba conchae. FIG. 30B shows a circuit diagram of such a device. FIG. 30C shows one variation of the device, and includes an alarm (e.g., an audible alarm that indicates to the user when to wear the device prior to stimulation, since the time between stimulations may be prolonged). The device may also include a retaining piece configured as a molded retainer. FIG. 30D shows another variation of a similar behind-the-ear device when worn by a subject. In this example the actuator region is positioned opposite the subject's cymba conchae.

In some variations, the stimulator receives feedback from one or more sensors. In particular, sensors for determining the level of one or more markers for inflammation may be useful to provide to help control or monitor stimulation. Any appropriate sensor may be used. For example, a sensor may be specific to detecting presence or levels of one or more cytokines. The sensor may be internal (e.g., implanted) or external. Feedback may be input by a controller or external device. In one example, blood is taken from the subject and analyzed for one or more markers, and this information is provided to the system or device for stimulating the subject's inflammatory reflex.

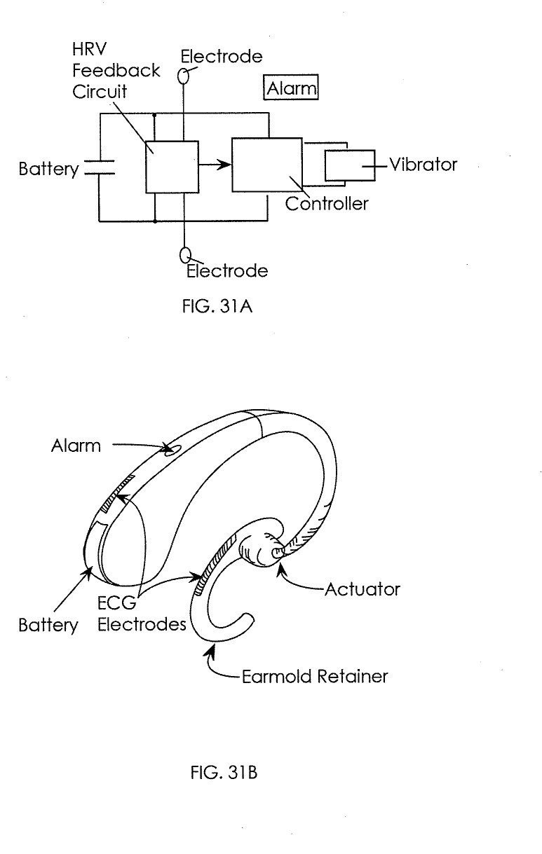

In some variations the stimulator or systems including the stimulator may include feedback to monitor one or more cardiac parameters, including heart rate, heart rate variability, tone, or the like. For example, the stimulator may include one or more ECG electrodes, such as the wearable stimulator shown in FIGS. 31A and 31B. FIG. 31A illustrates one example of a wearable stimulator for non-invasively stimulating a subject's inflammatory reflex. The variation shown in FIGS. 31A-31B may also be referred to as an aricular vegas mechanostimulator. In addition to the features described above for FIG. 30C, this stimulator also includes a plurality of sensors for detection of ECG signals. In this example, the sensors comprise two electrodes that contact the skin when the device is worn over the ear. As illustrated in FIG. 31A, the electrodes may provide input to a processor, which may be located within the housing of the device, including a heart rate variability (HRV) feedback circuit. The processor may receive and analyze ECG signals from the electrodes. Output (e.g, heart rate variability or an index of heart rate variability) may be provided to a controller which coordinates the stimulation applied. The controller may also be used to schedule treatments, and control the driver (which may be a part of the controller) and therefore the actuator (a vibrator in this example). The overall shape of the device illustrated in FIG. 31B is similar to the device shown in FIG. 30C, including an ear retainer (“earmold retainer”), housing and actuator. The device may include alternative or additional sensor, as mentioned briefly above.

In the embodiments in which the non-invasive stimulation is combined with invasive (e.g., additional electrical stimulation), an implanted vagus nerve stimulating device can be used. For example, the inflammatory reflex can be stimulated using an endotracheal/esophageal nerve stimulator (described, for example, in U.S. Pat. No. 6,735,471, incorporated herein by reference in its entirety), a transcutaneous nerve stimulator (as described for example in U.S. Pat. No. 6,721,603, incorporated herein by reference in its entirety) or a percutaneous nerve stimulator.

According to one embodiment of the present invention, in addition to the non-invasive stimulation, the inflammatory reflex can be stimulated invasively by delivering an electrical signal generated by any suitable vagus nerve stimulators. For example, a commercial vagus nerve stimulator such as the Cyberonics NCP™ can be modified for use. Other examples of nerve stimulators are described, for example, in U.S. Pat. Nos. 4,702,254; 5,154,172; 5,231,988; 5,330,507; 6,473,644; 6,721,603; 6,735,471; and U.S. Pat. App. Pub. 2004/0193231. The teachings of all of these publications are incorporated herein by reference in their entirety.

### An Exemplary Clinical Protocol

In one exemplary clinical treatment, the inflammatory reflex of patients with rheumatoid arthritis is to be inhibited by non-invasive stimulation. Inhibition of the inflammatory reflex is predicted to have a beneficial on subject's suffering from rheumatoid arthritis, which is an inflammatory disorder.

Inflammatory reflex stimulation in human subjects can be assessed by measuring its effect on autonomic function or monocyte cytokine and inflammatory marker synthesis. In rheumatoid arthritis (RA) subjects, the stimulation of the inflammatory reflex can also be assessed by disease activity and general health. Non-invasive stimulation of the inflammatory reflex is also referred to as non-invasive stimulation of the vagus nerve, because of the role that the vagus nerve has in the inflammatory reflex.

The activity of the autonomic nervous system, monocyte cytokine function, as well as other inflammatory markers is to be assessed in subjects with rheumatoid arthritis (n=12). A medical history and physical, as well as baseline measurements, will be conducted. A full physical examination, autonomic activity, clinical rheumatoid activity score will be assessed using the DAS-28 protocol. The DAS-28 score is a clinically validated composite disease activity score, measuring 28 defined joints. Basic lab tests (metabolic panel and CBC with differential) and monocyte cytokine synthesis and other inflammatory markers will be analyzed.

The non-invasive stimulation of the inflammatory reflex is to be administered at the cymba conchae (believed to have 100% vagus nerve enervation). This area is located posterior to the crus of the helix in the frontal part of the ear (see FIG. 1). The area will be stimulated for 5 minutes or less (e.g., 1 minute) with an oscillatory device. The oscillatory part of this pen-like device may be approximately 0.5 cm².

The neck area of the subject is to be avoided during stimulation in order to minimize side effects such as increased risk of stroke. Stimulation of the left auricular vagus nerve branch is preferred. By using the auricular branch, only minor side effects are anticipated, such as a vibrating sensation in the ear and head.

Non-invasive stimulation may be performed twice daily (8.00 am and 8.00 pm) for two days. Assessment of autonomic function, as well as cytokine and inflammatory marker analysis will then be conducted. Blood will be drawn at 0 hours before non-invasive stimulation, 40 minutes and 4 hours after non-invasive stimulation on day 1 and 2. Autonomic function will be assessed before stimulation (0 hours), during, 1 and 2 hours after stimulation on day 1 and day 2. The method is specified in detail below under the subheading “Assessment of Autonomic Function”.

Two follow-up visits may be taken, one at 48 hours and one at 168 hours at the out-subject unit. A physical (including DAS-28), blood draw (for CBC with differential, CRP, and cytokines) and assessment of autonomic function are conducted.

### Inflammatory Markers in Plasma

The following mediators which may indicate the inflammatory response are to be measured: TNF and HMGB-1. The total white blood cell count (WBC), CRP, IL-2, IL-4, IL-10, IFN-gamma, IL-8, IL-1b, IL-6, and IL-12p70 are also measured.

TNF can be measured using a standard commercially available ELISA kits; the other cytokines with the exception of HMGB-1 may be analyzed by Western blot. HMGB1 may be determined by the immunoblotting assay for serum.

Assessment of Autonomic Function

Subjects will be asked to rest comfortably in a sitting position in a chair. Ten minutes of cardiac monitoring and heart rate variability measurements are made before the procedure (non-invasive stimulation), during the five-minute procedure, and ten minutes afterwards. Monitoring includes continuous heart rate, blood pressure taken at 1-minute intervals, and oxygen saturation measured continuously. Autonomic function may be determined using the “CardioPro autonomic function analysis” software. Variation in beat-to-beat heart rate and respiratory sinus arrhythmia may be measured from ECG tracings imported into CardioPro software in real time through a digitizer; tracings of at least 20 minutes are typically obtained for analysis. Parasympathetic activity may be analyzed by measuring both low frequency (0.1 Hz; 6 cycles/min) and high frequency (0.25 Hz; 15 cycles/min) changes in heart rate. Spectral power analysis of the high frequency variations reveals respiratory sinus arrhythmia as an indicator of vagus activity. To determine vagus “tone,” or the amount of vagus nerve signals, the ratio of low frequency to high frequency variation may be computed. Skin temperature is measured with temperature probes attached to the index finger of the non-dominant hand; signals are recorded in the CardioPro software, and used to calculate variation in skin temperature over time. This data may also be correlated with plethysmography results, which are directly assessing peripheral perfusion measured with Laser Doppler and/or photoplethysmograpby. Skin conductance, also known as the galvanic skin response (GSR), can be measured with Ag/AgCl electrodes attached to the medial phalanx of the index and long fingers of the non-dominant hand; signals can be recorded in CardioPro and used to calculate sympathetic tone.

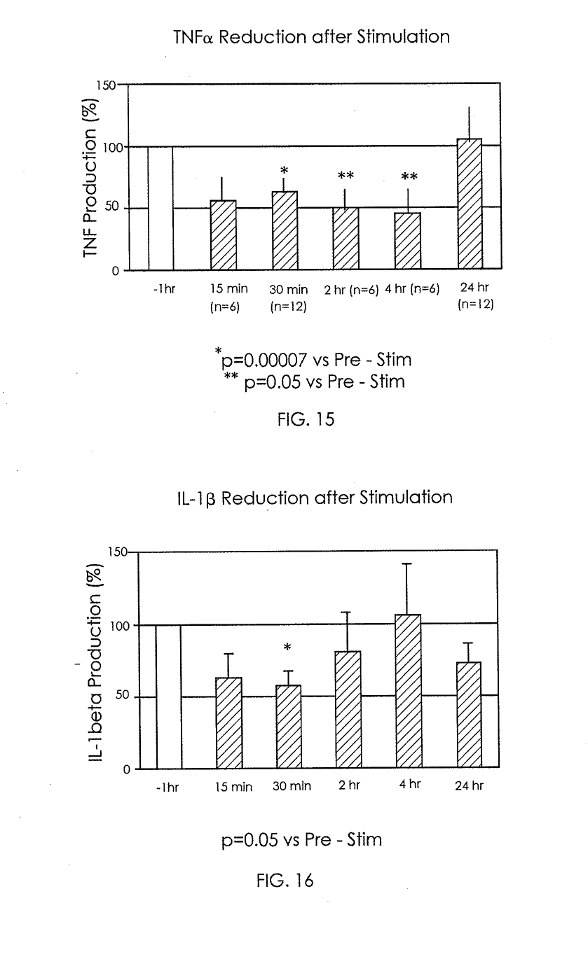

FIGS. 15-22 illustrate exemplary results using a protocol similar to that described above. In this example, human subjects were non-invasively stimulated for 1 minute on their right ear (in the cymba conchae region of the ear), in order to inhibit the inflammatory reflex. Data was collected showing a long-lasting inhibition of the inflammatory reflex. Stimulation was applied at approximately 250 Hz with a displacement of about 0.0001 to 5 mm (the displacement refers to the displacement during the motion of the actuator). Blood was drawn to test for the various markers of the inflammatory reflex, as described above.

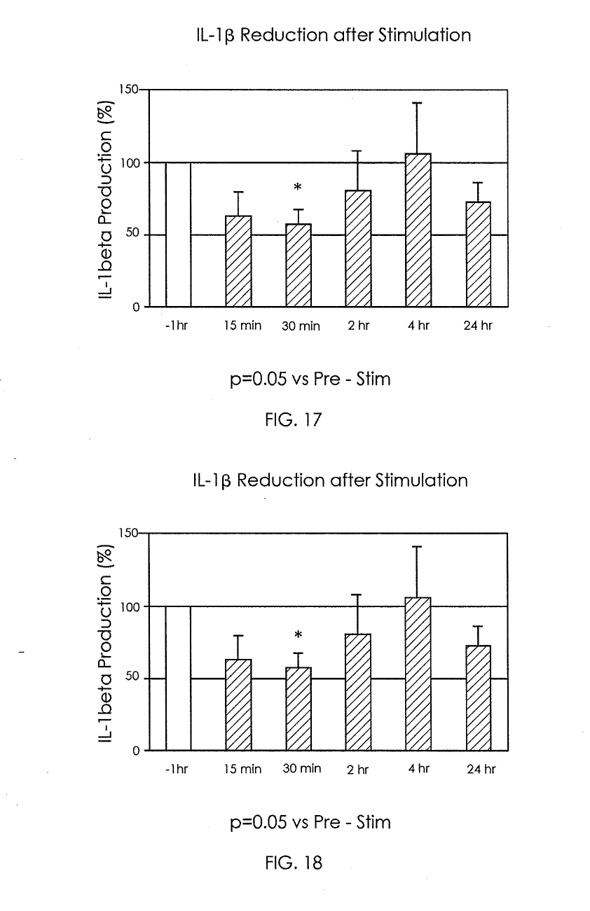

FIG. 15 illustrates the effect of non-invasive stimulation on TNFα levels. There was a substantial and significant reduction in TNFα levels following a one-minute non-invasive stimulation at 250 Hz, as described above. Moreover, the reduction in TNFα levels was long-lasting, as it remained low for over four hours. Similarly, FIG. 16 illustrates that there was also a significant reduction in IL-1β after stimulation. FIGS. 17 and 18 show similar decreases in the pro-inflammatory cytokines IL-6 (FIG. 17) and IL-8 (FIG. 18). In all of the pro-inflammatory cytokines examined, there was approximately a 50% decrease in level following non-invasive stimulation of the ear, resulting in the inhibition of the inflammatory reflex.

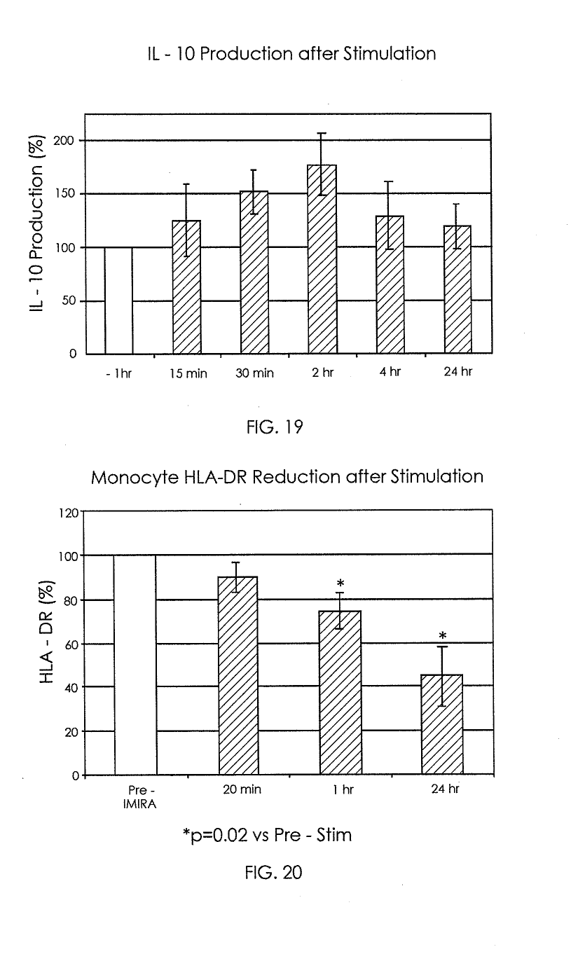

FIG. 19 shows the effect of non-invasive stimulation on an anti-inflammatory cytokine, IL-10 during the same stimulation period. As indicated in FIG. 19, there was no inhibition of IL-10, which appeared to increase in some subjects during the same time period, however the increase was not statistically significant.

In addition to the effect on cytokines seen in FIGS. 15-19, non-invasive stimulation of the inflammatory reflex as described above also inhibited cellular markers of inflammation. For example, FIG. 20 illustrates the effect of non-invasive stimulation on monocyte HLA-DR levels, and shows that stimulation resulted in a very long lasting (greater than 24 hour) inhibition of HLA-DR levels.

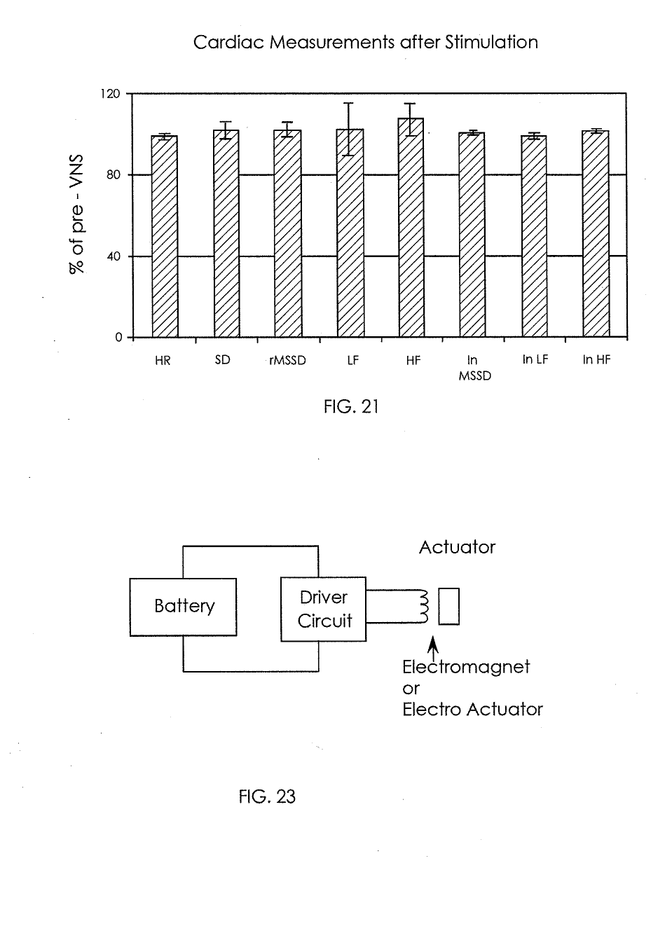

The stimulation appropriate for non-invasively stimulating a subject's inflammatory reflex in a manner that significantly reduces proinflammatory cytokines in the subject does not significantly affect cardiac measurements. This is illustrated for the measurements described above in FIG. 21. As shown in FIG. 21, there is no change in vagus-mediated cardiac measures following non-invasive stimulation of the inflammatory reflex. For example, heart rate (HR) and measures of heart rate variability (e.g., standard deviation of the normal-to-normal interval, SD; root mean square of the standard deviation of the normal-to-normal interval, rMSSD; low frequency component in normalized units, LF; high frequency in normalized units, HF; etc.) were unchanged.

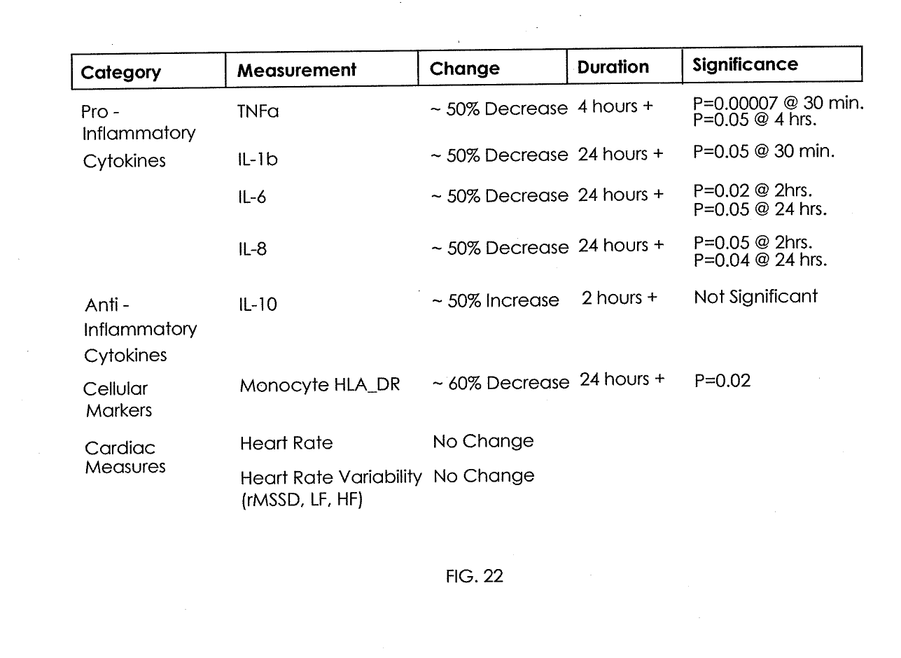

FIG. 22 is a table that summarizes the effect of non-invasive stimulation to inhibit the inflammatory reflex. Stimulation decreased circulating immune cell production of pro-inflammatory cytokines (TNFα, IL-1β, IL-6, and IL-8) for up to twenty-four hours. Stimulation also reduced circulating monocyte expression of HLA-DR, a cell surface marker of the inflammatory state. Finally the appropriate stimulation to inhibit the inflammatory reflex was achieved at sub-cardiac threshold vagus stimulation levels.

### ADDITIONAL EXAMPLES

### A. Example 1

### Non-Invasive Mechanical Stimulation of Vagus Nerve Reduces Serum TNF Level During Lethal Endotoxemia in Mice

BALB/c mice received an LD50 dose of endotoxin (7.5 mg/kg i.p.) five minutes prior to cervical massage.

The cervical massage was administered as follows. BALB/c mice were anesthetized with isoflurane and positioned as described above. Following a left submandibular sialoadenectomy and skin closure, animals received transcutaneous vagus nerve stimulation via cervical massage. Cervical massage was performed using alternating direct pressure applied perpendicularly and directly adjacent to the left lateral border of the trachea, using a cotton-tipped applicator. Each pressure application was defined as one stimulus. The number of stimuli was quantified by frequency and time. The lowest dose cervical massage group underwent 40 seconds of stimulation at 0.5 stimuli per second (20 total stimuli). The middle dose cervical massage group underwent two minutes of stimulation at one stimuli per second (120 total stimuli). The highest dose cervical massage group underwent five minutes of stimulation at two stimuli per second (600 total stimuli). Sham cervical massage mice underwent sialoadenecetomy only.

The treatment groups then underwent cervical massage using low dose (20 impulses), intermediate dose (120 impulses) or high dose stimulation (600 impulses). An impulse is defined as one touch of the vagus nerve. Blood was collected two hours after endotoxin administration and serum TNF was determined by ELISA.

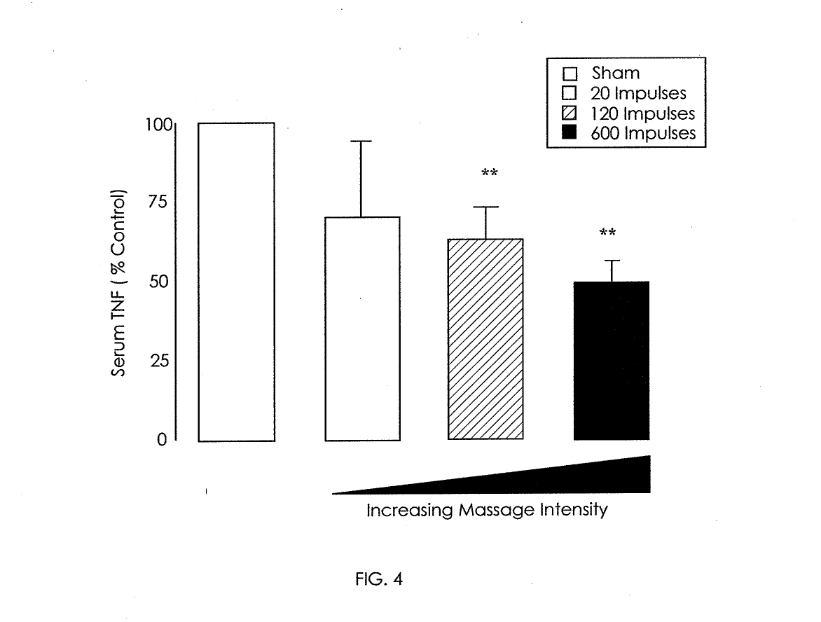

FIG. 4 presents the data. Data are presented as mean ±sem (n=6-8 per group: **=p<0.05). As can be seen, non-invasive mechanical stimulation of the vagus nerve reduced serum TNF level in a dose-dependent manner. Mice which received 600 impulses show a two-fold reduction in serum TNF level.

### B. Example 2

### Non-Invasive Mechanical Stimulation of Vagus Nerve Reduces HMGB1 Levels in Septic Mice

Serum HMGB1 levels were determined in BALB/c mice subjected to cecal ligation and puncture (CLP). CLP was performed as follows.

Balb/c mice were anesthetized with 75 mg/kg Ketamine (Fort Dodge, Fort Dodge, Iowa) and 20 mg/kg of xylazine (Bohringer Ingelheim, St. Joseph, Mo.) intramuscularly. A midline incision was performed, and the cecum was isolated. A 6-0 prolene suture ligature was placed at a level 5.0 mm from the cecal tip away from the ileocecal valve.

The ligated cecal stump was then punctured once with a 22-gauge needle, without direct extrusion of stool. The cecum was then placed back into its normal intra-abdominal position. The abdomen was then closed with a running suture of 6-0 prolene in two layers, peritoneum and fascia separately to prevent leakage of fluid. All animals were resuscitated with a normal saline solution administered sub-cutaneously at 20 ml/kg of body weight. Each mouse received a subcutaneous injection of imipenem (0.5 mg/mouse) (Primaxin, Merck & Co., Inc., West Point, Pa.) 30 minutes after the surgery. Animals were then allowed to recuperate.

Cervical massage (according to the protocol described in Example 1) or sham treatment was started 24 hours after the surgical procedure. Blood was collected 44 hours after the CLP procedure. HMGB1 level was determined by western blot and densitometry analysis.

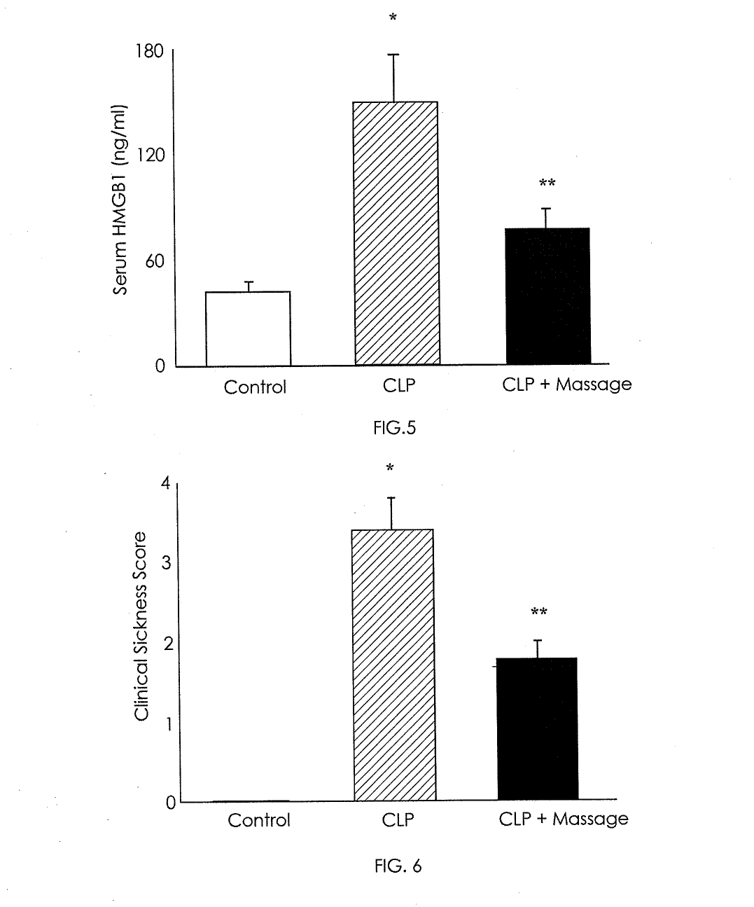

The data is presented in FIG. 5. Data are presented as mean +/−sem (n=6-8: **p<0.05). As can be seen, mechanical stimulation of the VN reduced the HMGB1 level by nearly two-fold.

### C. Example 3

### Non-Invasive Mechanical Stimulation of Vagus Nerve Reduces Clinical Signs of Sepsis

BALB/c mice were subjected to CLP procedure and non-invasive mechanical vagus nerve stimulation as described in Example 2.

Following the mechanical VN stimulation, clinical sepsis scores were determined 44 hours after the CLP procedure. Total clinical score (range 0 to 6) is composed of four components: presence or absence of diarrhea, piloerection, decreased activity level and spontaneous eye opening.

The data is presented in FIG. 6. A maximum score of six per animal denotes highest clinical sickness level. Data are presented as mean +/−sem (n=1-6: **p<0.05).

As can be seen, mechanical VN stimulation results in nearly two-fold reduction of the clinical scores of septic mice.

### D. Example 4

### Non-Invasive Mechanical Stimulation of Vagus Nerve Improves Survival of Sepsis Mice

BALB/c mice were subjected to cecal ligation and puncture (CLP) as described in Example 2 and randomized to receive cervical massage (600 impulses) or sham massage starting 24 hours alter CLP, and thereafter administered two times per day for two days.

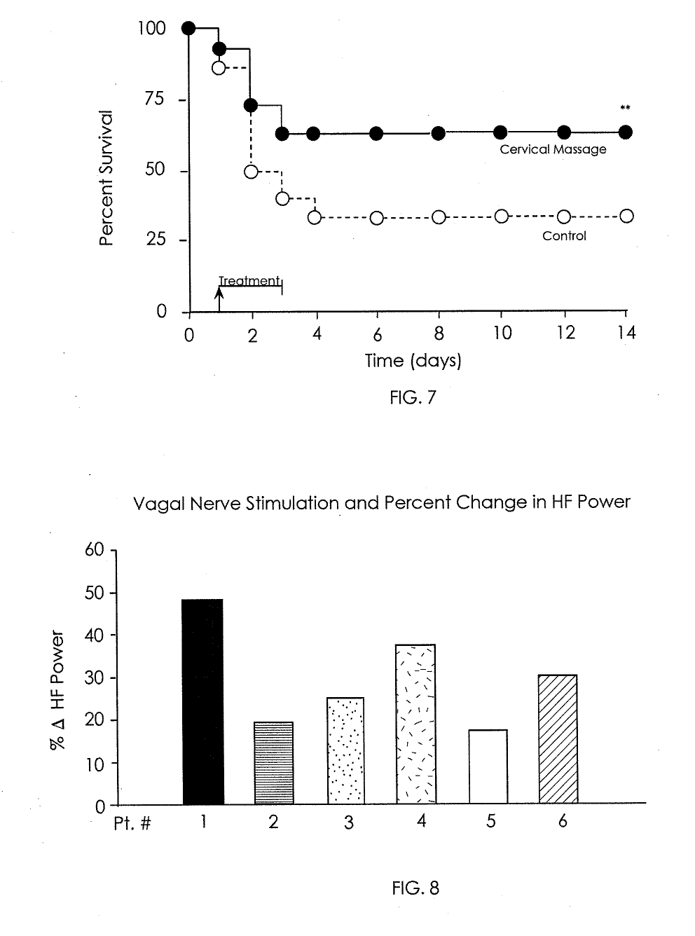

FIG. 7 presents the data. (Arrow and line represent the beginning and duration of treatment.) Data are shown as percent of animals surviving [n>25 per group: **=p<0.05 (two-tailed log rank test)].

As can be seen, non-invasive mechanical stimulation of the VN improves the survival rate 3-fold (from 25% to 75%).

### E. Example 5

### Non-Invasive Mechanical Auricular Vagus Nerve Stimulation Activates Autonomic (Parasympathetic) Functions

As indicated above, autonomic activities (e.g. heart rate or breathing rate) can serve as indicia of the vagus nerve activity. Specifically, variation in beat-to-beat heart rate and respiratory sinus arrhythmia can be measured from ECG tracings and then imported into analysis software such as CardioPro™ in real time through a digitizer. Parasympathetic activity was analyzed in six subjects by measuring both low frequency (0.1 Hz; 6 cycles/min) and high frequency (0.25 Hz; 15 cycles/min) changes in heart rate. Spectral power analysis of the high frequency variations reveals respiratory sinus arrhythmia as an indicator of vagus activity.

Tracings of at least 20 minutes have been obtained from six subjects that received external auricular vagal stimulation according to the protocol described above (see An Exemplary Clinical Protocol) and subjected to the spectral power analysis.

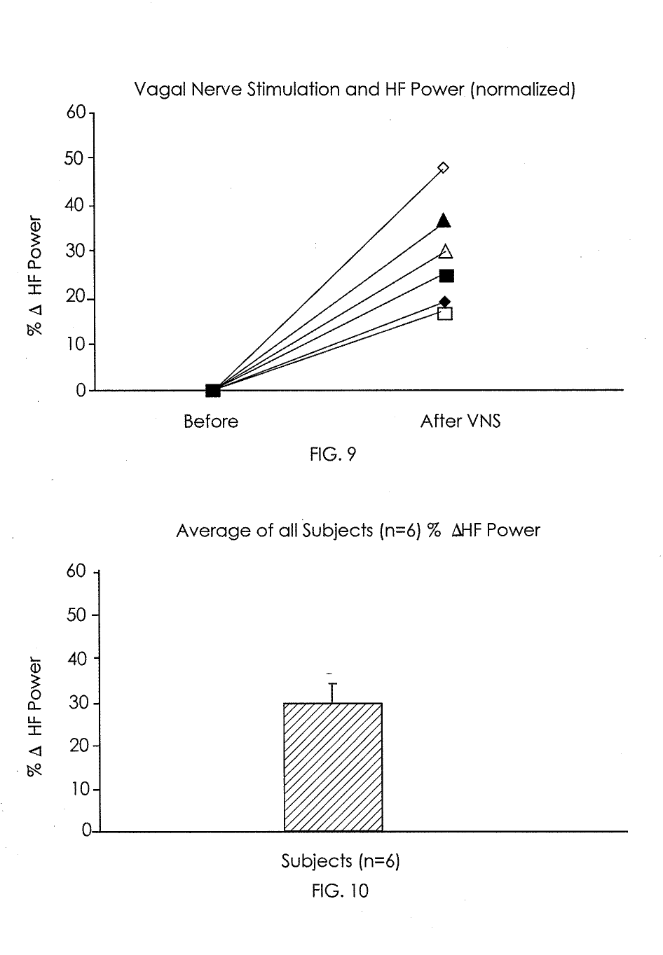

Results presented in FIG. 8, FIG. 9, and FIG. 10 show the percent change in high frequency power (HF Power) in the group of six subjects that received external (non-invasive) auricular vagal stimulation. Specifically, healthy human subjects received external stimulation of the vagus nerve by a mechanical, oscillating stimulator applied to the pinna of the ear.

As the data in FIGS. 8-10 demonstrate, the result is an increase in HF power, between 20% to 50% (in case of subject #1) as shown in FIG. 8, reflecting a stimulation of the vagus nerve in all subjects.

The table shown in FIG. 11 compiles numerical data for an analysis of instantaneous heart rate variability from these six subjects (A through F). Data in the columns were derived from standardized software (CardioPro™) to reveal increases in vagus nerve activity when the vagus nerve is stimulated non-invasively. The following abbreviations are used: “CS” means carotid stimulation; “SDNN” means Standard Deviation of the NN interval, where NN interval is the Normal-to-Normal interval; “NN50” means the number of pairs of adjacent NN intervals differing by more than 50 ms in the entire recording; “pNN50” means the proportion derived by dividing NN50 by the total number of NN intervals; “RMSSD” means the square root of the mean squared differences of successive NN intervals; “VLFN” means Very Low Frequency in Normalized units; “LFN” means Low Frequency in Normalized units; “HFN” means High Frequency in Normalized units; “LF/HF” means LF to HF ratio; “HR” means Heart Rate; “BR” means Breathing Rate.

### F. Example 6

### Non-Invasive Mechanical Auricular Vagus Nerve Stimulation Results in Improvement in Rheumatoid Arthritis Symptoms in an Human Subject

A subject suffering from RA was subjected to non-invasive mechanical auricular vagus nerve stimulation on the right ear and the results were compared to those in a healthy volunteer.

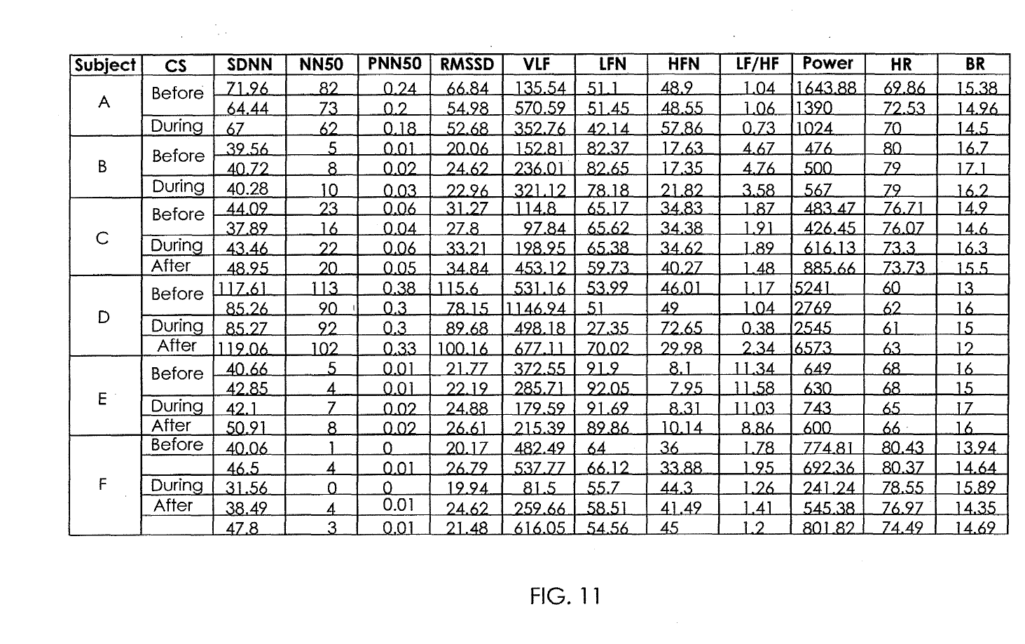

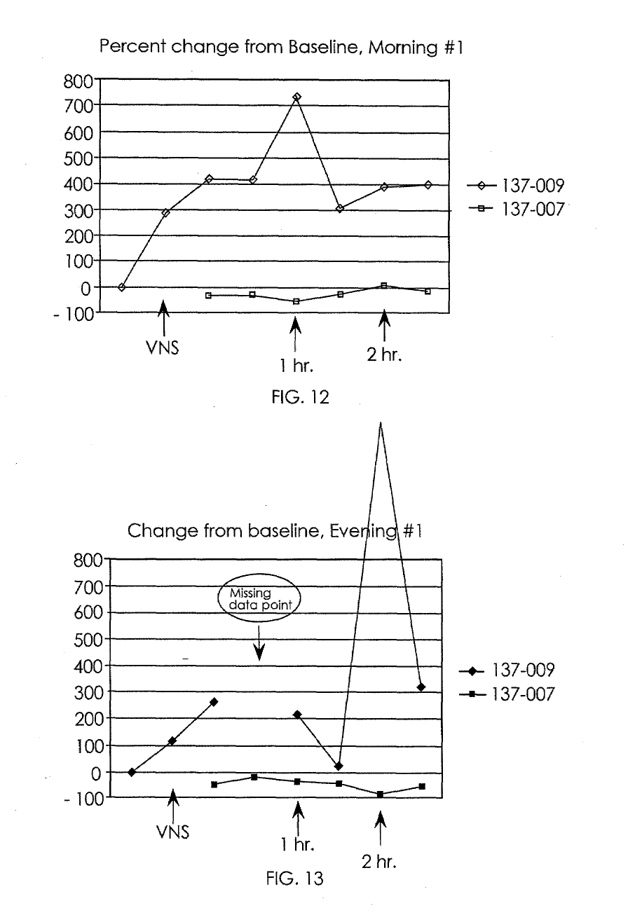

Initially, the parameters of the stimulation were determined. Subjects were allowed to rest comfortably for 5 minutes. The subject's heart rate variability (HRV) was then measured for 15 minutes. Next, the subject's ear (e.g., auricular branch of the vagus nerve) region was non-invasively stimulated while continuing to measure HRV. HRV was measured for 15 additional minutes after stimulation was complete. The percent-change in HRV (high frequency) from baseline between groups was compared. The results are presented in FIG. 12 (morning) and FIG. 13 (evening). Diamonds denote the data points obtained for an RA subject; squares denote the data points obtained for a healthy volunteer who was not stimulated. (The parameter from each comparison that yields the greatest increase in HRV can be used for all groups in the subsequent experiments.)

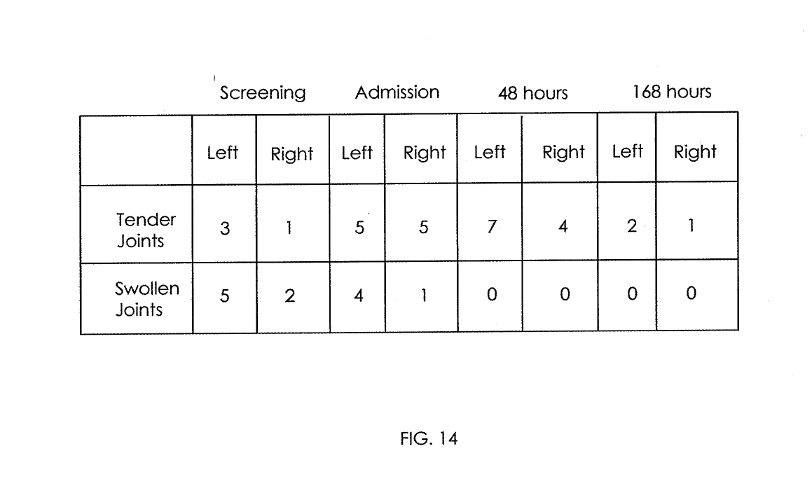

The subject was stimulated twice daily for two days. The stimulator was applied to the ear for ten minutes, and the subject monitored for 168 hours. The table in FIG. 14 shows the clinical scores of the RA subject. As can be seen, the clinical score shows significant improvement after mechanical stimulation of the vagus nerve.

While this invention has been particularly shown and described with references to example embodiments thereof, it will be understood by those skilled in the art that various changes in form and details may be made therein without departing from the scope of the invention encompassed by the appended claims.

What is claimed is:

1. A method of treating an inflammatory disorder, the method comprising:
non-invasively stimulating a subject's inflammatory reflex in a manner that significantly reduces proinflammatory cytokines in the subject.

2. The method of claim 1, wherein the non-invasive stimulation comprises mechanical stimulation of the subject's cymba conchae region of their ear.

3. The method of claim 1, wherein the non-invasive stimulation comprises stimulation between about 50 and 500 Hz.

4. The method of claim 1, wherein the non-invasive stimulation comprises stimulation of less than 5 minutes.

5. The method of claim 1, wherein the non-invasive stimulation comprises stimulation for about 1 minute.

6. The method of claim 1, wherein the non-invasive stimulation comprises a temporal pattern that does not allow accommodation of mechanoreceptors in the region of stimulation during the stimulation period.

7. The method of claim 1, wherein the non-invasive stimulation comprises mechanical stimulation of the subject's cymba conchae region of their ear for between about 50 and 500 Hz for about one minute.

8. The method of claims 1, wherein the non-invasive stimulation is applied to the subject's area innervated by the seventh (facial) cranial nerve or cranial nerve V.

9. The method of claim 1, wherein the non-invasive stimulation is applied to at least one location selected from the subject's cymba conchae of the ear, or helix of the ear.

10. The method of claim 1, wherein the non-invasive stimulation is applied to at least one point along the spleen meridian.

11. The method of claims 1, wherein the inflammatory disorder is selected from the group consisting of appendicitis, peptic ulcer, gastric ulcer, duodenal ulcer, peritonitis, pancreatitis, ulcerative colitis, pseudomembranous colitis, acute colitis, ischemic colitis, diverticulitis, epiglottitis, achalasia, cholangitis, cholecystitits, hepatitis, Crohn's disease, enteritis, Whipple's disease, allergy, anaphylactic shock, immune complex disease, organ ischemia, reperfusion injury, organ necrosis, hay fever, sepsis, septicemia, endotoxic shock, cachexia, hyperpyrexia, eosinophilic granuloma, granulomatosis, sarcoidosis, septic abortion, epididymitis, vaginitis, prostatitis, urethritis, bronchitis, emphysema, rhinitis, pneumonitits, pneumotransmicroscopic silicovolcanoconiosis, alvealitis, bronchiolitis, pharyngitis, pleurisy, sinusitis, influenza, respiratory syncytial virus infection, HIV infection, hepatitis B virus infection, hepatitis C virus infection, disseminated bacteremia, Dengue fever, candidiasis, malaria, filariasis, amebiasis, hydatid cysts, burns, dermatitis, dermatomyositis, sunburn, urticaria, warts, wheals, vasulitis, angiitis, endocarditis, arteritis, atherosclerosis, thrombophlebitis, pericarditis, myocarditis, myocardial ischemia, periarteritis nodosa, rheumatic fever, Alzheimer's disease, coeliac disease, congestive heart failure, adult respiratory distress syndrome, meningitis, encephalitis, multiple sclerosis, cerebral infarction, cerebral embolism, Guillame-Barre syndrome, neuritis, neuralgia, spinal cord injury, paralysis, uveitis, arthritides, arthralgias, osteomyelitis, fasciitis, Paget's disease, gout, periodontal disease, rheumatoid arthritis, synovitis, myasthenia gravis, thyroiditis, systemic lupus erythematosis, Goodpasture's syndrome, Behcet's syndrome, allograft rejection, graft-versus-host disease, Type I diabetes, Type II diabetes, ankylosing spondylitis, Berger's disease, Reiter's syndrome, Hodgkin's disease, ileus, hypertension, irritable bowel syndrome, myocardial infarction, sleeplessness, anxiety and stent trombosis.

12. The method of claims 1, wherein the inflammatory disorder is rheumatoid arthritis.

13. A method of treating an inflammatory disorder, the method comprising:
non-invasively stimulating a subject's ear to stimulate the inflammatory reflex in a manner that significantly reduces the proinflammatory cytokines in the subject.

14. The method of claim 13, wherein the non-invasive stimulation comprises mechanical stimulation of the subject's cymba conchae region of their ear.

15. The method of claim 13, wherein the non-invasive stimulation comprises stimulation between about 50 and 500 Hz.

16. The method of claim 13, wherein the non-invasive stimulation comprises stimulation of less than 5 minutes.

17. The method of claim 13, wherein the non-invasive stimulation comprises stimulation for about 1 minute.

18. The method of claim 13, wherein the non-invasive stimulation comprises a temporal pattern that does not allow accommodation of mechanoreceptors in the region of stimulation during the stimulation period.

19. The method of claim 13, wherein the non-invasive stimulation comprises mechanical stimulation of the subject's cymba conchae region of their ear for between about 50 and 500 Hz for about one minute.

20. The method of claims 13, wherein the non-invasive stimulation is applied to the subject's area innervated by the seventh (facial) cranial nerve or cranial nerve V.

21. The method of claim 13, wherein the non-invasive stimulation is applied to at least one location selected from the subject's cymba conchae of the ear, or helix of the ear.

22. The method of claim 13, wherein the non-invasive stimulation is applied to at least one point along the spleen meridian.

23. The method of claims 13, wherein the inflammatory disorder is selected from the group consisting of appendicitis, peptic ulcer, gastric ulcer, duodenal ulcer, peritonitis, pancreatitis, ulcerative colitis, pseudomembranous colitis, acute colitis, ischemic colitis, diverticulitis, epiglottitis, achalasia, cholangitis, cholecystitits, hepatitis, Crohn's disease, enteritis, Whipple's disease, allergy, anaphylactic shock, immune complex disease, organ ischemia, reperfusion injury, organ necrosis, hay fever, sepsis, septicemia, endotoxic shock, cachexia, hyperpyrexia, eosinophilic granuloma, granulomatosis, sarcoidosis, septic abortion, epididymitis, vaginitis, prostatitis, urethritis, bronchitis, emphysema, rhinitis, pneumonitits, pneumotransmicroscopic silicovolcanoconiosis, alvealitis, bronchiolitis, pharyngitis, pleurisy, sinusitis, influenza, respiratory syncytial virus infection, HIV infection, hepatitis B virus infection, hepatitis C virus infection, disseminated bacteremia, Dengue fever, candidiasis, malaria, filariasis, amebiasis, hydatid cysts, burns, dermatitis, dermatomyositis, sunburn, urticaria, warts, wheals, vasulitis, angiitis, endocarditis, arteritis, atherosclerosis, thrombophlebitis, pericarditis, myocarditis, myocardial ischemia, periarteritis nodosa, rheumatic fever, Alzheimer's disease, coeliac disease, congestive heart failure, adult respiratory distress syndrome, meningitis, encephalitis, multiple sclerosis, cerebral infarction, cerebral embolism, Guillame-Barre syndrome, neuritis, neuralgia, spinal cord injury, paralysis, uveitis, arthritides, arthralgias, osteomyelitis, fasciitis, Paget's disease, gout, periodontal disease, rheumatoid arthritis, synovitis, myasthenia gravis, thyroiditis, systemic lupus erythematosis, Goodpasture's syndrome, Behcet's syndrome, allograft rejection, graft-versus-host disease, Type I diabetes, Type II diabetes, ankylosing spondylitis, Berger's disease, Reiter's syndrome, Hodgkin's disease, ileus, hypertension, irritable bowel syndrome, myocardial infarction, sleeplessness, anxiety and stent trombosis.

24. The method of claims 13, wherein the inflammatory disorder is rheumatoid arthritis.

25. A method of treating an inflammatory disorder, the method comprising:
mechanically stimulating a subject's ear to stimulate the inflammatory reflex in a manner that significantly reduces the proinflammatory cytokines in the subject.

26. The method of claim 25, wherein the non-invasive stimulation comprises mechanical stimulation of mechanoreceptors within the subject's cymba conchae region of their ear.

27. The method of claim 25, wherein the non-invasive stimulation comprises stimulation between about 50 and 500 Hz.

28. The method of claim 25, wherein the non-invasive stimulation comprises stimulation of less than 5 minutes.

29. The method of claim 25, wherein the non-invasive stimulation comprises stimulation for about 1 minute.

30. The method of claim 25, wherein the non-invasive stimulation comprises a temporal pattern that does not allow accommodation of mechanoreceptors in the region of stimulation during the stimulation period.

31. The method of claim 25, wherein the non-invasive stimulation comprises mechanical stimulation of the subject's cymba conchae region of their ear for between about 50 and 500 Hz for about one minute.

32. The method of claims 25, wherein the non-invasive stimulation is applied to the subject's area innervated by the seventh (facial) cranial nerve or cranial nerve V.

33. The method of claim 25, wherein the non-invasive stimulation is applied to at least one location selected from the subject's cymba conchae of the ear, or helix of the ear.

34. The method of claim 25, wherein the non-invasive stimulation is applied to at least one point along the spleen meridian.

35. The method of claims 25, wherein the inflammatory disorder is selected from the group consisting of appendicitis, peptic ulcer, gastric ulcer, duodenal ulcer, peritonitis, pancreatitis, ulcerative colitis, pseudomembranous colitis, acute colitis, ischemic colitis, diverticulitis, epiglottitis, achalasia, cholangitis, cholecystitits, hepatitis, Crohn's disease, enteritis, Whipple's disease, allergy, anaphylactic shock, immune complex disease, organ ischemia, reperfusion injury, organ necrosis, hay fever, sepsis, septicemia, endotoxic shock, cachexia, hyperpyrexia, eosinophilic granuloma, granulomatosis, sarcoidosis, septic abortion, epididymitis, vaginitis, prostatitis, urethritis, bronchitis, emphysema, rhinitis, pneumonitits, pneumotransmicroscopic silicovolcanoconiosis, alvealitis, bronchiolitis, pharyngitis, pleurisy, sinusitis, influenza, respiratory syncytial virus infection, HIV infection, hepatitis B virus infection, hepatitis C virus infection, disseminated bacteremia, Dengue fever, candidiasis, malaria, filariasis, amebiasis, hydatid cysts, burns, dermatitis, dermatomyositis, sunburn, urticaria, warts, wheals, vasulitis, angiitis, endocarditis, arteritis, atherosclerosis, thrombophlebitis, pericarditis, myocarditis, myocardial ischemia, periarteritis nodosa, rheumatic fever, Alzheimer's disease, coeliac disease, congestive heart failure, adult respiratory distress syndrome, meningitis, encephalitis, multiple sclerosis, cerebral infarction, cerebral embolism, Guillame-Barre syndrome, neuritis, neuralgia, spinal cord injury, paralysis, uveitis, arthritides, arthralgias, osteomyelitis, fasciitis, Paget's disease, gout, periodontal disease, rheumatoid arthritis, synovitis, myasthenia gravis, thyroiditis, systemic lupus erythematosis, Goodpasture's syndrome, Behcet's syndrome, allograft rejection, graft-versus-host disease, Type I diabetes, Type II diabetes, ankylosing spondylitis, Berger's disease, Reiter's syndrome, Hodgkin's disease, ileus, hypertension, irritable bowel syndrome, myocardial infarction, sleeplessness, anxiety and stent trombosis.

36. The method of claims 25, wherein the inflammatory disorder is rheumatoid arthritis.

37. A method of treating an inflammatory disorder, the method comprising:
mechanically stimulating a subject's cymba conchae region of the ear for less than five minutes in a manner that significantly reduces the proinflammatory cytokines in the subject.

38. A device for non-invasively stimulating a subject's inflammatory reflex, the device comprising:
a movable distal tip region configured to mechanically stimulate at least a portion of a subject's ear;
a handle; and
a driver configured to move the distal tip region between about 50 and 500 Hz.

39. The device of claim 38, further comprising a controller configured to control the driver so that it stimulates for less than 5 minutes.

40. The device of claim 38, wherein the driver comprises a motor.

41. The device of claim 38, wherein the driver comprises a voice coil.

42. The device of claim 38, wherein the distal tip region has a diameter of between about 35 mm and about 8 mm.

43. The device of claim 38, further comprising a frequency generator in communication with the driver.

44. A wearable device for non-invasively stimulating a subject's inflammatory reflex, the device comprising:
an actuator configured to mechanically stimulate a subject's cymba conchae;
a driver configured to move the distal tip region between about 50 and 500 Hz; and
an ear attachment region configured to secure to at least a portion of a subject's ear.

45. The device of claim 44, further comprising an alert configured to indicate that the device should be worn.

46. The device of claim 44, further comprising a memory configured to record treatment parameters.

47. The device of claim 44, further comprising feedback to detect delivery of stimulation.

48. The device of claim 44, wherein the actuator is selected from the group consisting of: electromagnet, bimorph, piezo crystal, electrostatic actuator, speaker coil, and rotating magnet or mass.

49. The device of claim 44, further comprising a driver circuit for controlling the amplitude, frequency, and duty cycle of the driver.

50. The device of claim 44, further comprising a device body including the ear attachment region configured to conform to the subject's ear.

51. The device of claim 44, further comprising a therapy timer configured to limit the duration of stimulation.

52. The device of claim 44, further comprising a battery.
